(19) United States
(12) Patent Application Publication
(10) Pub. No.: US 2023/0222582 A1
(43) Pub. Date: Jul. 13, 2023

(54) DIGITAL PRODUCT SUITE FOR THE ISSUANCE AND TRADING OF A VARIETY OF ASSET CLASSES AND ENTITIES

(71) Applicant: Templum, Inc., New York, NY (US)

(72) Inventor: CHRISTOPHER PALLOTTA, Mt. Pleasant, SC (US)

(21) Appl. No.: 18/095,392

(22) Filed: Jan. 10, 2023

Related U.S. Application Data
(60) Provisional application No. 63/298,405, filed on Jan. 11, 2022.

(51) Int. Cl. G06Q 40/04

(52) U.S. Cl. CPC G06Q 40/04

(57) ABSTRACT

The digital product suite allows for the primary issuance secondary trading, capitalization table management, and distribution of dividends for a variety of asset classes and entities. The digital product suite generally comprises a primary issuance module, a quotation bureau module, a qualified matching service module, and an issuer module.

### CROSS-REFERENCE TO RELATED APPLICATIONS

This application claims priority to U.S. Provisional Application Ser. No. 63/298,405, filed Jan. 11, 2022, the entire contents of which are hereby incorporated by reference in their entirety.

### FIELD OF THE INVENTION

The present invention relates to the asset life cycle of financial instruments. More particularly, the present invention discloses a digital product suite (DAPS) for the primary issuance, secondary trading, capitalization table management, and distribution of dividends for a variety of asset classes and entities.

### BACKGROUND

Current issuance and trading platforms are generally utilized to trade financial instruments such as stocks, mutual funds, bonds, etc. For example, a user can purchase shares of a publicly available corporate equity utilizing one of any well-known trading platforms. However, these platforms do not have the capabilities required to trade other types of asset classes, such as the non-publicly available equity securities that may require the platform to have the ability to request executed documents, negotiate a sale price, etc. Therefore, a need clearly exists for a digital product suite for the creation, primary issuance, governance and administration, and secondary trading for a variety of asset classes and entities.

### SUMMARY

Disclosed herein is a digital product suite for the primary issuance secondary trading, capitalization table management, and distribution of dividends for a variety of asset classes and entities. The DAPS generally comprises a primary issuance module, a quotation bureau module, a qualified matching service module, an issuer module, and a platform management module.

### BRIEF DESCRIPTION OF THE DRAWINGS

FIG. 1 depicts an exemplary screen of the primary issuance module graphical user interface (GUI) according to the present invention.

FIG. 2 depicts an exemplary accreditation screen.

FIG. 3 depicts an exemplary screen for collecting additional onboarding information.

FIG. 4 depicts an exemplary customizable offering screen.

FIG. 5 depicts an exemplary received order screen.

FIG. 6 depicts an exemplary investor's portfolio screen.

FIG. 7 depicts an exemplary trade blotter screen.

FIG. 8 depicts an exemplary investor trading screen.

FIG. 9 depicts an exemplary portfolio screen.

FIG. 10 depicts an exemplary custodian account screen.

FIG. 11 depicts a flowchart showing the steps used for issuer approval.

FIG. 12 depicts a flowchart showing steps for a purchase agreement.

FIG. 13 depicts an exemplary purchase agreement screen.

FIG. 14 depicts a flowchart showing the steps used for custodian clearing and settlement.

FIG. 15 depicts an exemplary quotation bureau screen.

FIG. 16 depicts an exemplary screen for creating a listing.

FIG. 17 depicts an exemplary screen for submitting indications.

FIG. 18 depicts an exemplary screen for reviewing indications.

FIG. 19 depicts an exemplary acceptance screen.

FIG. 20 depicts an exemplary second window.

FIG. 21 depicts an exemplary counter order screen.

FIG. 22 depicts an exemplary issuer module screen.

FIGS. 23 and 24 depicts exemplary deal tracking screens.

FIG. 25 depicts an exemplary screen for managing dynamic cap tables.

FIG. 26 depicts an exemplary whitelist and blacklist screen.

FIG. 27 depicts an exemplary quotation bureau screen.

FIG. 28 depicts an exemplary screen for approving trades.

FIG. 29 depicts an exemplary home screen for an administrative platform.

FIG. 30 depicts an exemplary investor administration screen.

FIG. 31 depicts an exemplary screen for editing offer details.

FIG. 32 depicts an exemplary screen for approving listings.

FIG. 33 depicts an exemplary screen for cap table management.

FIG. 34 depicts an exemplary ATS setting screen.

FIG. 35 depicts an exemplary setting screen for securities.

FIG. 36 depicts an exemplary screen for creating rules.

FIG. 37 depicts an exemplary rule listing screen.

FIG. 38 depicts an exemplary screen showing a history of all actions generated by rules.

FIG. 39 depicts an exemplary order listing screen.

FIG. 40 depicts an exemplary order blotter.

FIG. 41 depicts an exemplary trade blotter.

FIG. 42 depicts an exemplary architecture of the DAPS.

### DETAILED DESCRIPTION

The DAPS of the present invention provides an end-to-end technology platform for the creation, primary issuance, governance and administration, and secondary trading for a variety of asset classes and entities. The DAPS includes five core modules:
Primary issuance module to facilitate the fundraising process for primary offerings
Alternate trading system (ATS) for automated matching and execution of trades
Quotation Bureau module for bulletin-board style trading module for Investors to negotiate peer-to-peer resale of assets
Issuer module for issuers to manage and monitor activity issuances and trading of primary and secondary asset classes
Administrative module for licensed representatives to manage markets, assets, data, and users

The DAPS enables financial institutions to accelerate adoption of next generation infrastructure. The DAPS supports a variety of asset classes and use cases including, but not limited to, LP interest & funds, debt products, digital currencies, sports gambling, collectibles & rare items, commodities, and gaming.

Primary Issuance Module

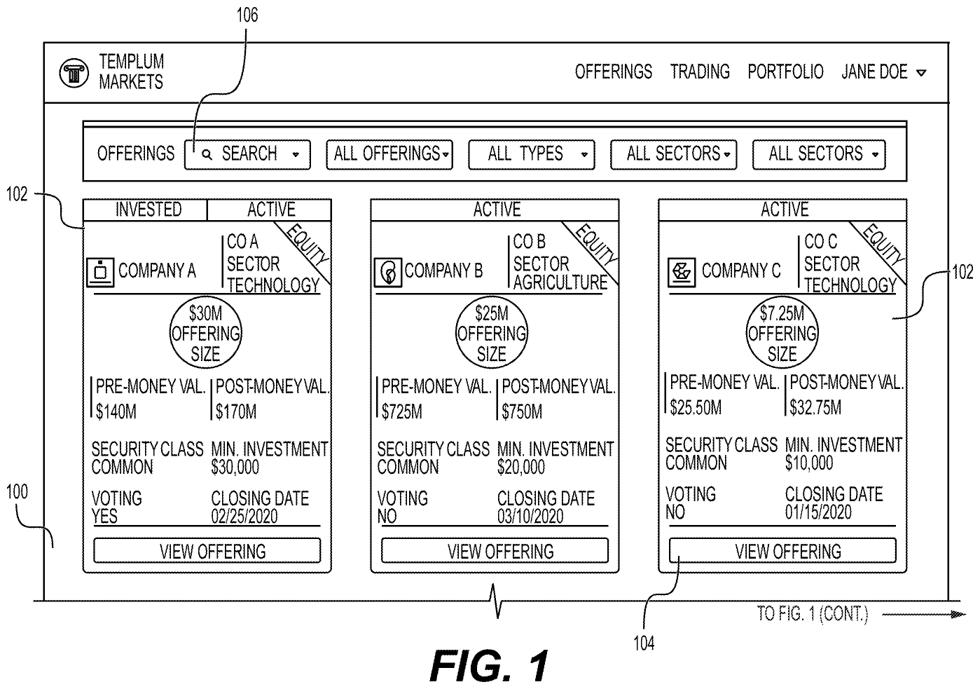

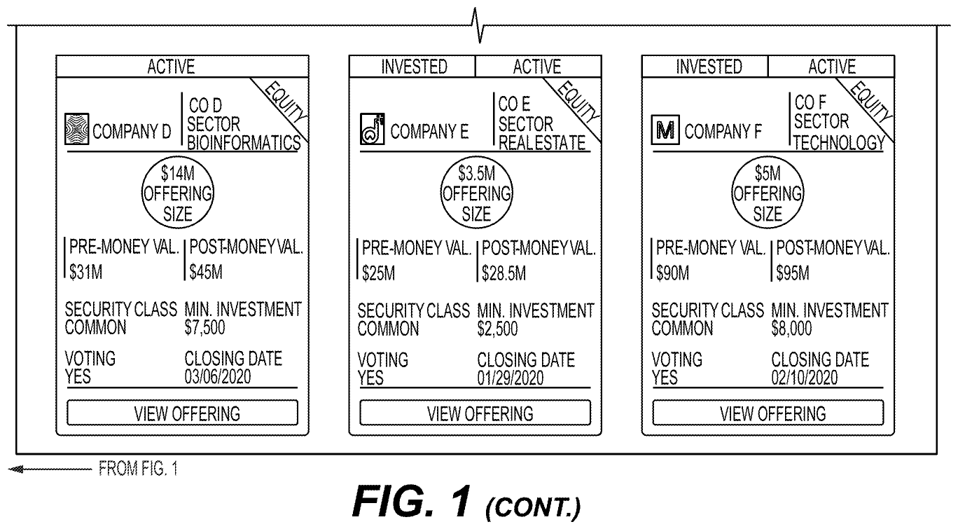

A sample screen of the primary issuance module GUI 100 is depicted in FIG. 1. The primary issuance modules supports an entire transaction life cycle, from deal origination through closing.

As shown, each offering is accorded its own window 102 which are arranged in a bulletin board style for easy review by a user. Each window comprises brief key information about each offering and such as name, ticker symbol, pre money valuation, post money valuation, minimum investment, security class, etc. More comprehensive information about each offering can be viewed by selecting “View Offering” selection 104. The top of the page comprises a search bar 106 as well as a plurality of filters to allow users to filter the offerings according to type, sectors, etc.

The primary issuance module allows for: Investor onboarding through know your client (KYC) and anti-money laundering (AML) processes; due diligence including asset creation, non-disclosure agreement (NDA) signatures, and data hosting; book building including order placement and management; deal closing including payment and signatures; and share allocation. Deal closing may also include, at the option of the issuer, obtaining the investors' signature on documents (as applicable based on the offering type).

Investor Onboarding

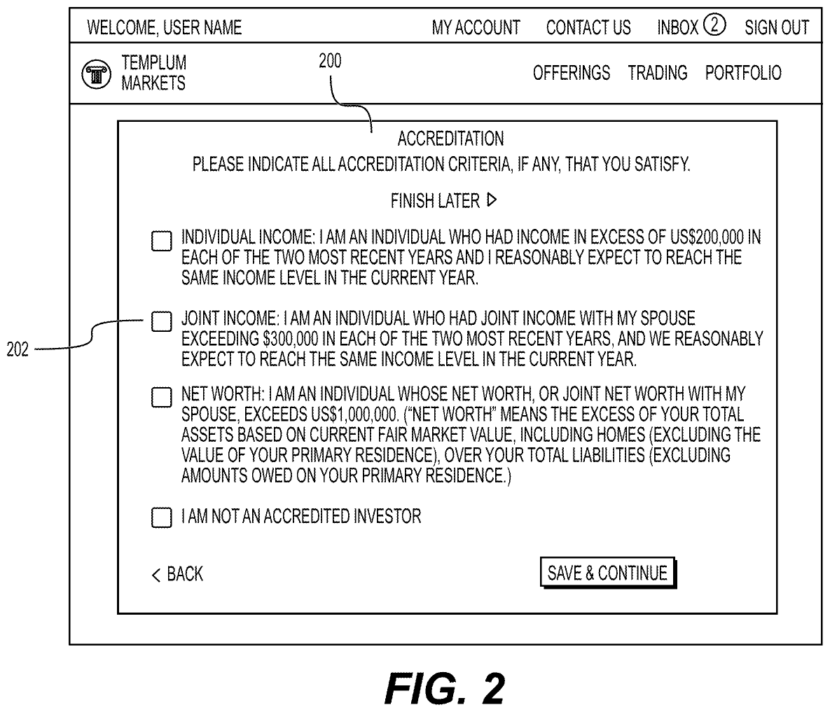

In order to be able to invest and trade offerings, institutional, non-credited, retail, and accredited individuals must first be onboarded, which can be accomplished through the primary issuance module. The Investor onboarding includes KYC & AML verification for institutional Investors, qualified institutional Buyers, individual qualified purchasers, and accredited Investors. Because the offerings traded through DAPS generally differ from the trading of traditional securities such as stocks and bonds, the onboarding process includes the collection of information such as Investor address & contact information, accreditation/qualified purchaser selection, suitability and risk tolerance questionnaire, trusted contact, government ID, Tax ID Number, affiliations (FINRA, publicly traded company, politically exposed person), etc. Information from investors concerning investments is collected in alternatives because non-accredited investors cannot hold more 10% of their portfolio in Reg A securities (per regulatory rules). An investor's accreditation status can also be used to dictate which offerings are visible to the investor. A sample accreditation screen 200 is depicted in FIG. 2 in which a selection 202 is made as to the basis for the accreditation including individual income, joint income, or net worth. The requirements for qualifying as an accredited Investor are defined under US securities law and are regularly revised.

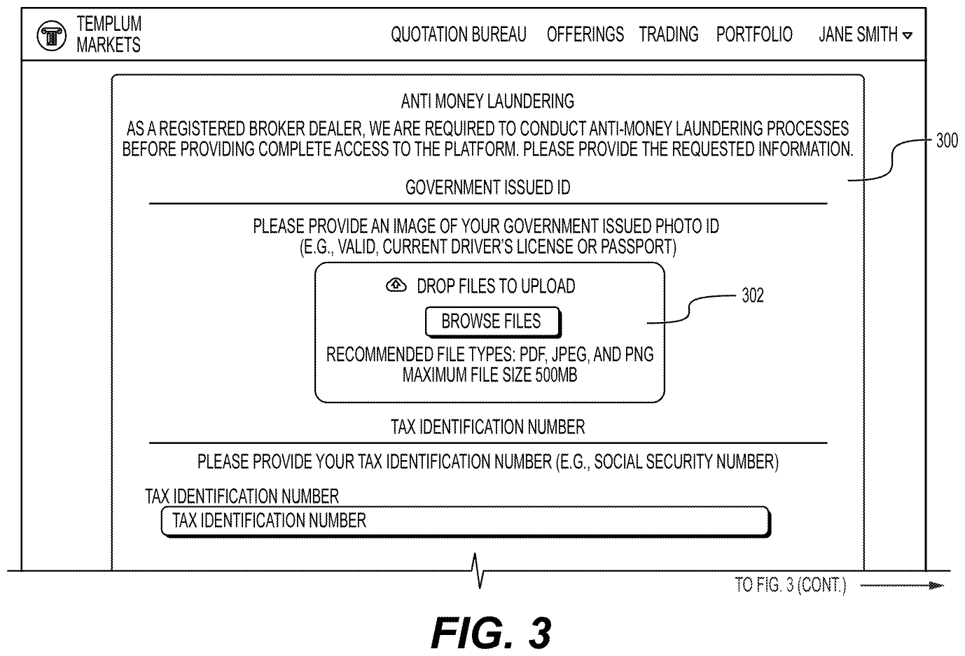

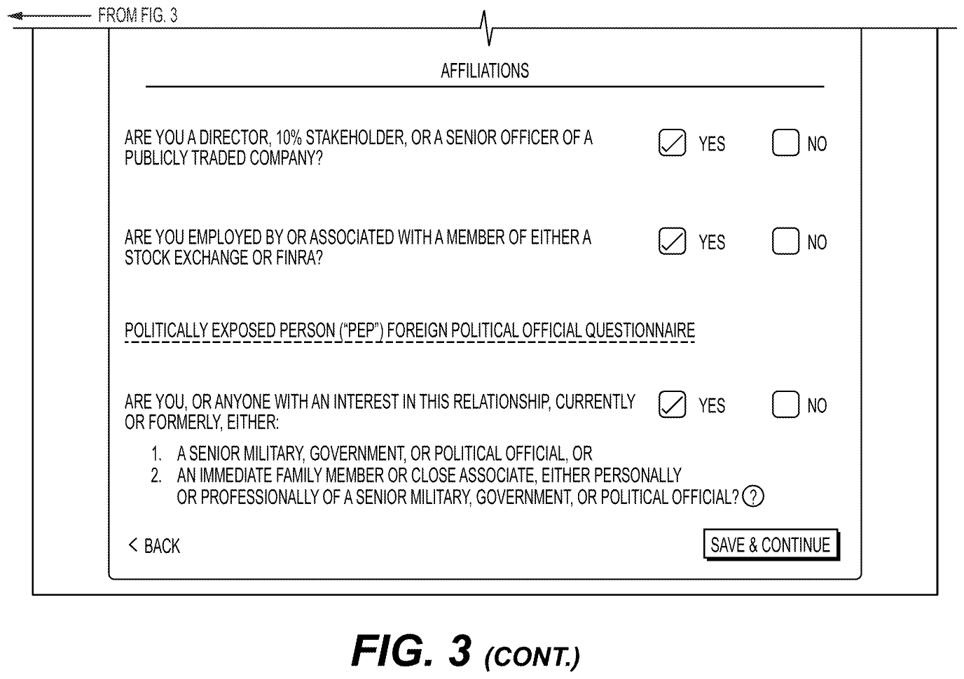

FIG. 3 depicts an audit screen 300 in which additional information is collected for the onboarding process such as Tax ID Number, Affiliations, etc. In some instances, documentation may need to be collected for review and approval during the onboarding process so a drag and drop system 302 is preferably used to allow users to easily provide the requested information. After all of the required information has been submitted, Investors are assigned a status throughout the process which dictates which offerings are available and the level of information available. The onboarding process can be customized by integrating any KYC provider or AML provider of choice. Institutional accounts can be created with sub-accounts that with assigned permissions in the DAPS.

Offering Page and Due Diligence

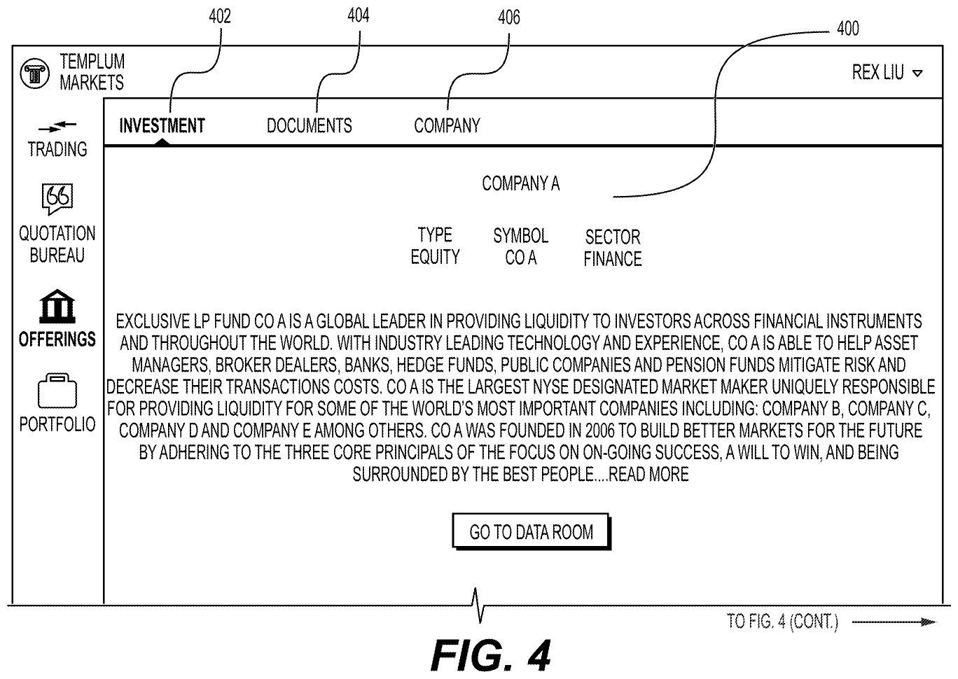

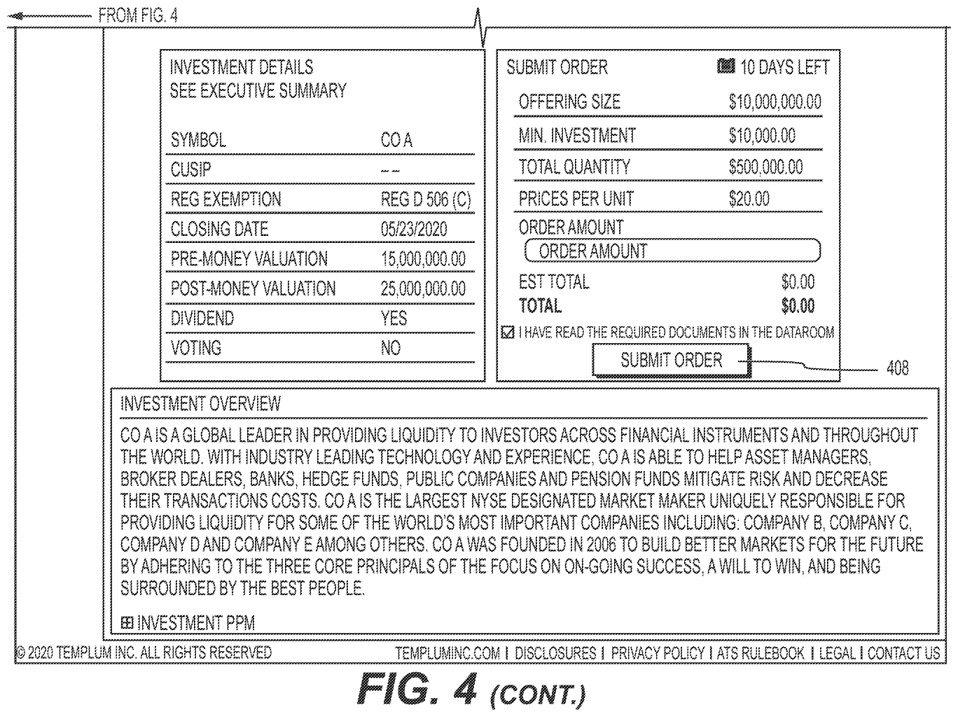

After Investors have been onboarded and approved, they are free to browse available issuances for offerings. Each issuance is preferably provided with its own customizable offering page 400, a sample of which is depicted in FIG. 4. Asset types, data, images, and documents for each offering are customizable and managed directly in the administration platform which will be described later. Information about the offering is provided on the “investment” tab 402. Additional documentation concerning the investment are available under the “documents tab” 404 and information about the company is available under the “company” tab 406.

An Investor can submit an offer directly from the offering page by entering the required information and selecting “submit order” button 408. The data room is preferably natively hosted within DAPS, with audit trails, watermarking, and date stamping. A third-party data room can be linked from the offering page if required.

NDA integration is also available as required. Investors must digitally sign an NDA through DocuSign (or similar service provider) before data room and sale details are available. Real time analytics based on deal activity are available including Investor views, NDA signatures, documents downloaded, and orders placed, with date/timestamp and user ID. Administrators can create private and public sales for each issuance with fixed or rolling close dates.

Book Building & Deal Closing

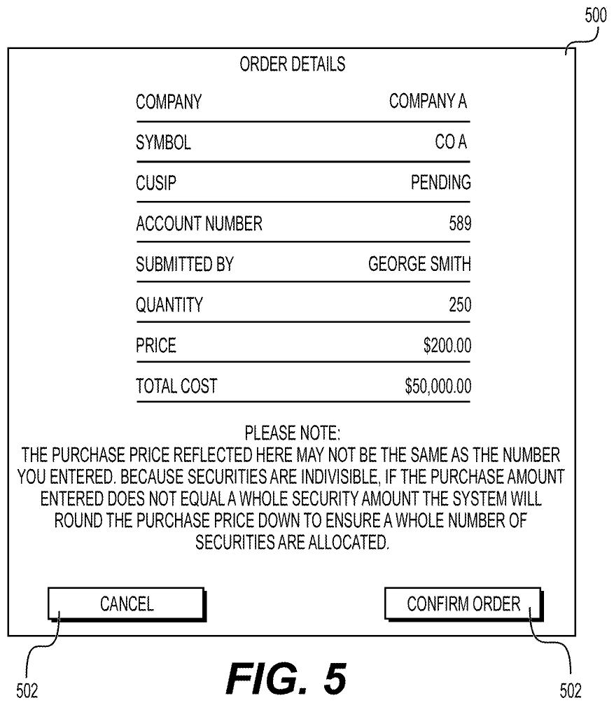

The primary issuance module further allows issuers to receive and manage orders, subscription documents, and payments all within the DAPS. As already shown in FIG. 4, Investors can submit orders from the offering page. The issuers must then review and manage the order and confirm the number of shares per order. An example of a received order 500 for review is depicted in FIG. 5. The order detail includes information such as company name, symbol, Committee on Uniform Security Identification Procedures (CUSIP) status, account number, submitter, quantity, price, and total cost. The issuer can choose to confirm or cancel 502 the order.

When an order is submitted, the primary issuance model automatically populates the required documents and transmits them to Investors for execution through DocuSign. Closing package documents can be customized for each deal through the Administrative platform.

Administrators can view and manage all orders for any issuance with real time data and analytics for every deal. Administrators can also customize payment methods for each deal through any rail provider.

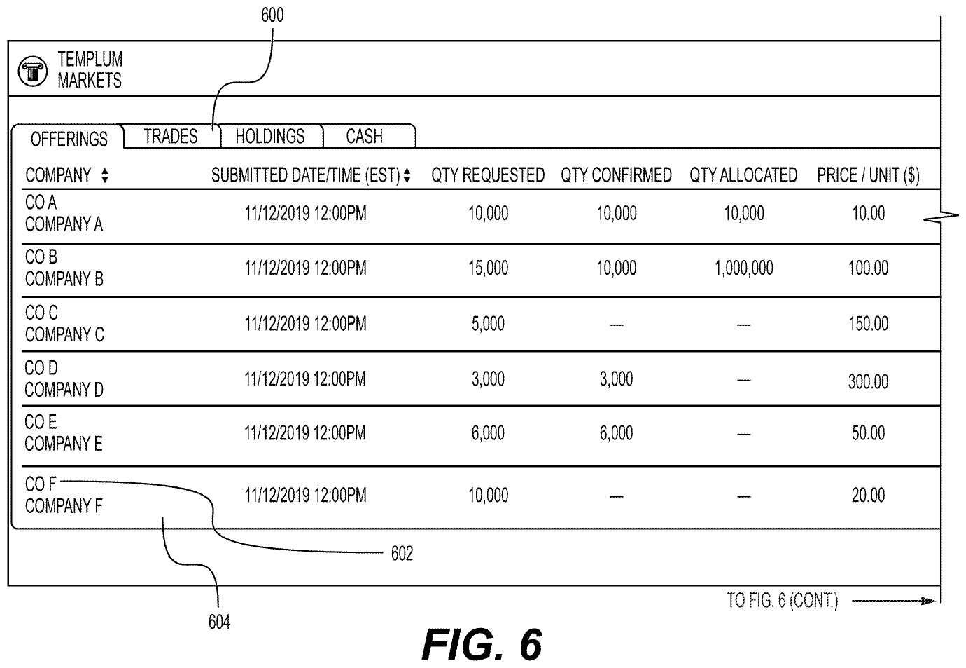

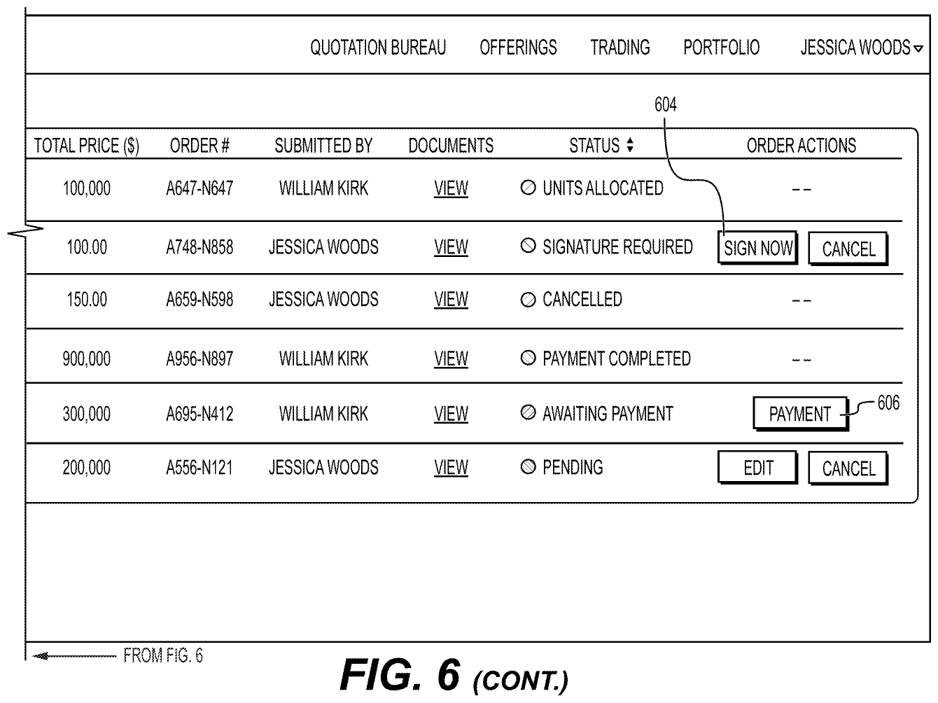

Upon order allocation by the issuer, a cap table is automatically generated and shares are sent to each Investor's portfolio page 600 as depicted in FIG. 6. The allocation process can be configured for each deal to either occur automatically as part of the payment process, or to be done in batch as part of the close process for the deal. The portfolio page 600 allows investors to have separate screens from issuers and administrators that can be configured at the user account level. The order 602 for AJUD requires a signature and the Investor can click “Sign Now” button 604 to execute the required documents, after which the status is updated. The order 604 for LOPL requires payment from the Investor. The Investor can click the “Payment” button 606 which allows the Investor to provide payment through any bank integration or wire transfer through APIs. Integration with a registered third-party escrow agent is also available to hold funds until deal closing is available.

ATS for Secondary Trading

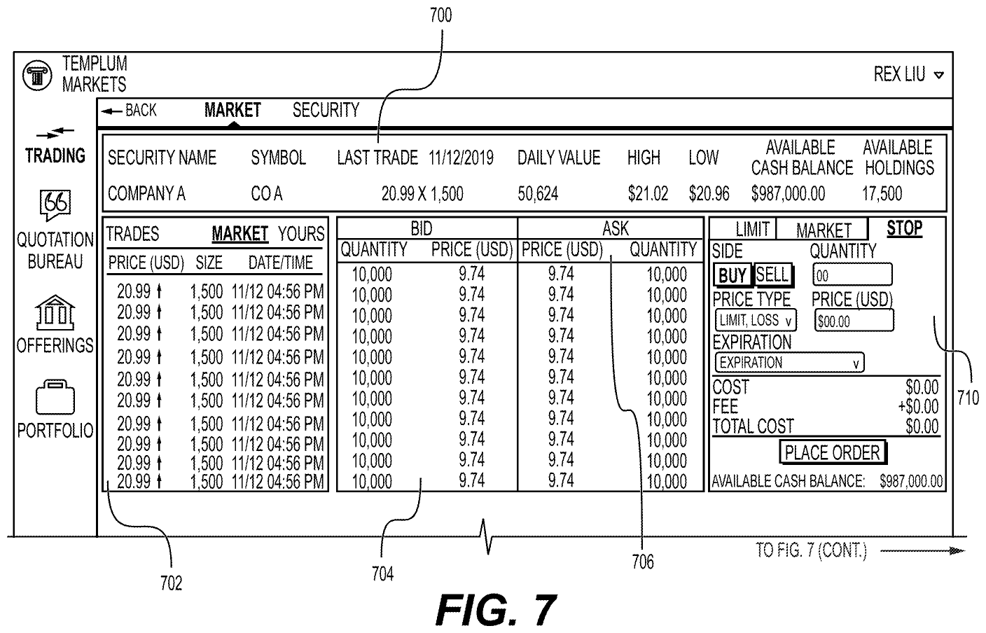

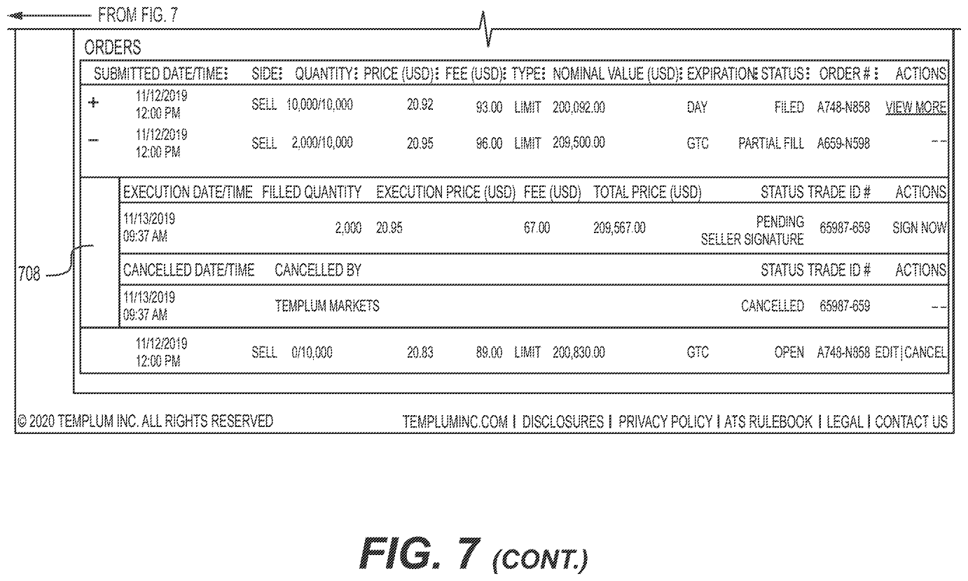

The ATS allows Investors to trade offerings after issuance. Assets trading in secondary can either be migrated from primary or loaded into the system for the purposes of secondary trading. FIG. 7 depicts a trade blotter 700 for the symbol UBRT. Information allowing the Investor to make an educated offer are provided such as recent trades and price 702, bids 704, asks 706, and completed order details 708. The Investor can choose to place a limit, market, or stop order for the offering using order selection 710. A matching engine is provided which matches Investors with other Investors selling share allocations. Similar to the features offered through the primary issuance module, options are provided to allow Investors to submit payment and sign any required documents.

Trading Interface

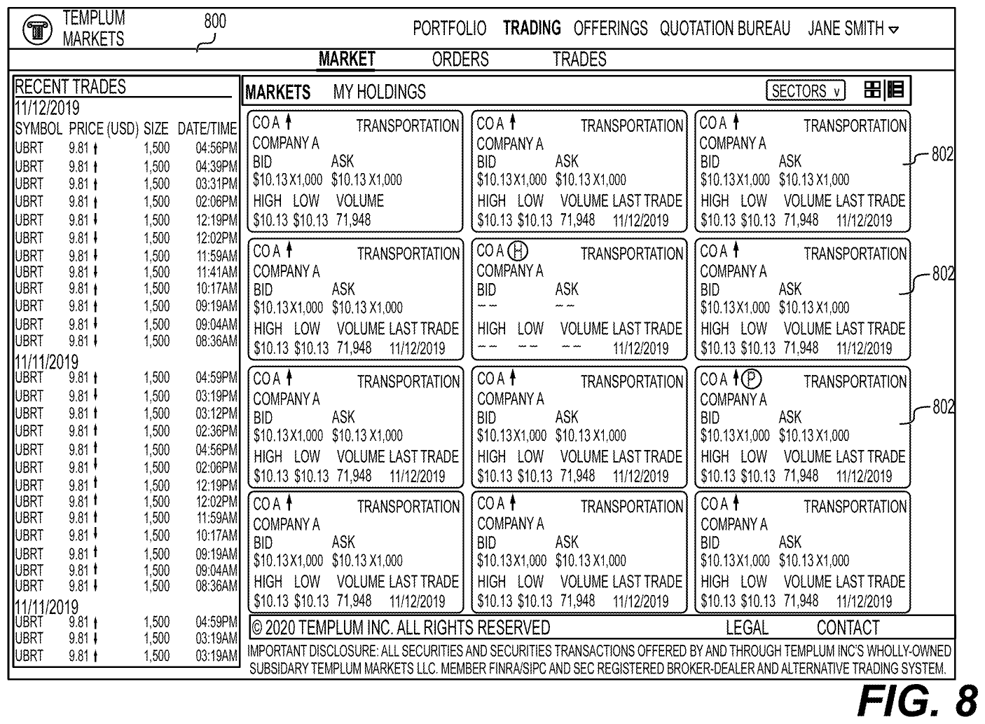

The ATS trading interface creates a frictionless trading experience for Investors with a data rich interface. A variety of screens are available to the Investors to allow them to view their trades in multiple formats. FIG. 8 depicts an Investor trading screen 800 in which each trade is assigned its own window 802 to give the Investor a brief history of all of their recent trades. FIG. 9 depicts a portfolio page 900 similar to that of FIG. 6. The Investor can see all of their recent orders on this trade including status 902 and required actions. The Investor can directly sign any documents from this page, provide payment, or cancel pending order.

The ATS matching engine provides low-latency matching between Investors and enables high frequency trading and settlement for any asset class listed on the ATS. All of the trading data including orders, trades, prices, etc. from the ATS can be accessed through market data APIs for consumption by third party systems. All data provided by the market data APIs may be standardized using the Financial Information eXchange (FIX) protocol to enable traditional capital markets distribution.

The ATS also provides surveillance and monitoring capabilities, allowing for the creation of customized rules based on market data and to define automated system responses. These are set at the security level, or globally within the environment. Order quantity, price, value, trading volume, price changes, and user activity can all be used to create monitoring and surveillance rule sets. Based on desired criteria, the ATS can automatically enact market restrictions such as halting trading for a security, freezing or limiting Investor accounts, creating Administrator alerts, and/or blocking orders before trades are entered.

Trade Settlement

The ATS allows the post-trade settlement lifecycle to be customized for each asset class. The ATS can integrate with a variety of banking and custodial partners, such as DriveWealth, to instantly settle trades directly in the platform. Cash management features to deposit and withdraw funds are available with a banking or payment partner integration. With this option, Investor trades are restricted to values less than or equal to available cash balance, thereby reducing the risk exposure for the exchange.

Integrated DocuSign functionality streamlines the signature of purchase agreements, if needed, during the post-trade settlement process. For each security/offering, an option to offer Issuers right of first refusal (ROFR) on each trade is included. Issuer approval can be configured to be required before any trade is settled. Upon trade settlement, the cap table for the offering is automatically updated, and Investors will see updated holdings in their portfolio (FIG. 6).

After a trade is matched in the matching engine of the ATS, a trade will need to be settled. This process ensures that a trade, after executed in the ATS, becomes binding. This may include issuer confirmation, signature of a Purchase Agreement, the transfer of cash and securities, payment of fees, and update to the cap table. The following definitions will be used throughout the description:

| Term/Acronym | Definition |
|---|---|
| Security | An asset that is available for secondary trading in |
| | the ATS. Each security is linked to a single company |
| | in DAPS. Each company can have multiple securities |
| | (and multiple primary offerings). |
| Order | A buy or sell request submitted in the ATS. Orders |
| | are matched in the matching engine and then filled |
| | either partially or in full. |
| Trade | An executed order, meaning that a single trade is |
| | equivalent to the match of two different orders |
| | (one buy and one sell) that are completely filled. |
| | A single order can be split into multiple trades |
| | if it was partially filled. |
| Purchase | The document that must be signed by both the Buyer |
| Agreement | and Seller to make the trade binding and actionable. |
| (PA) | |
| Trade | The process that makes a trade in the ATS binding |
| Settlement | and complete. This includes signature of the PA by |
| | both the Buyer and Seller, transfer of cash, payment |
| | of fees, notification or approval (if required), and |
| | the update of the cap table with the new holder of units. |
| User | The Buyer and/or Seller in the DAPS. The user interacts |
| | with the ATS through the ATS UI. |
| Custodian | DAPS integrates with a Custodian. The custodian is |
| | a third party entity licensed to custody cash and |
| | securities on behalf of users. The Custodian will |
| | create brokerage accounts for DAPS users and will |
| | hold cash and securities for DAPS users. These |
| | activities are all based on instruction from the user |
| | through the marketplace interface. |
| User Bank | The user's personal bank account. Upon user onboarding, |
| | individual users will be required to link a bank account, |
| | and transfer funds from their personal bank account |
| | to the Custodian account. |

A trade is created when two orders are matched through the ATS matching engine, or when two parties have anonymously negotiated and agreed to a transaction in the Quotation Bureau. Once a trade is created, the settlement process for the trade begins. If the system has a flag on the security that trades require issuer approval, the issuer is notified of the trade and is asked to confirm it via the issuer platform. If the system has a flag on the security that a purchase agreement (PA) is required, the PA is generated which includes the Buyer name, the Seller name, the price and quantity. The generated PA is then sent to the Buyer to sign. Once the Buyer signs, the PA is sent to the Seller to sign.

After all signatures have been received, payment is transferred from the Buyer account to Seller account. Payment is also transferred from both accounts to DAPS to cover any fees. Once cash is transferred, the cap table for the offering is updated.

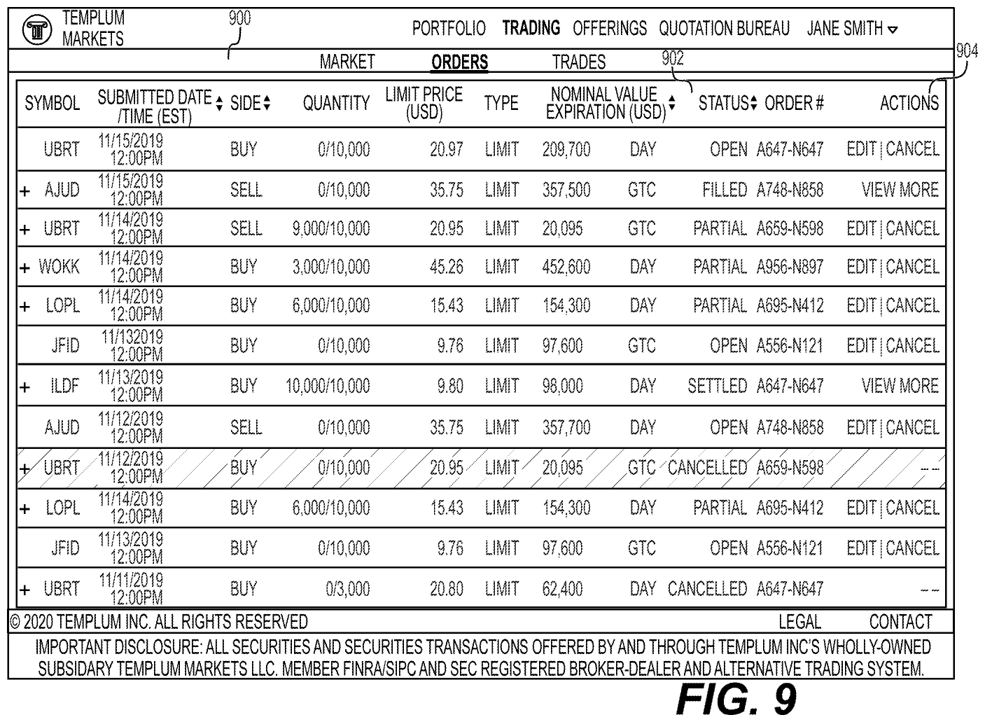

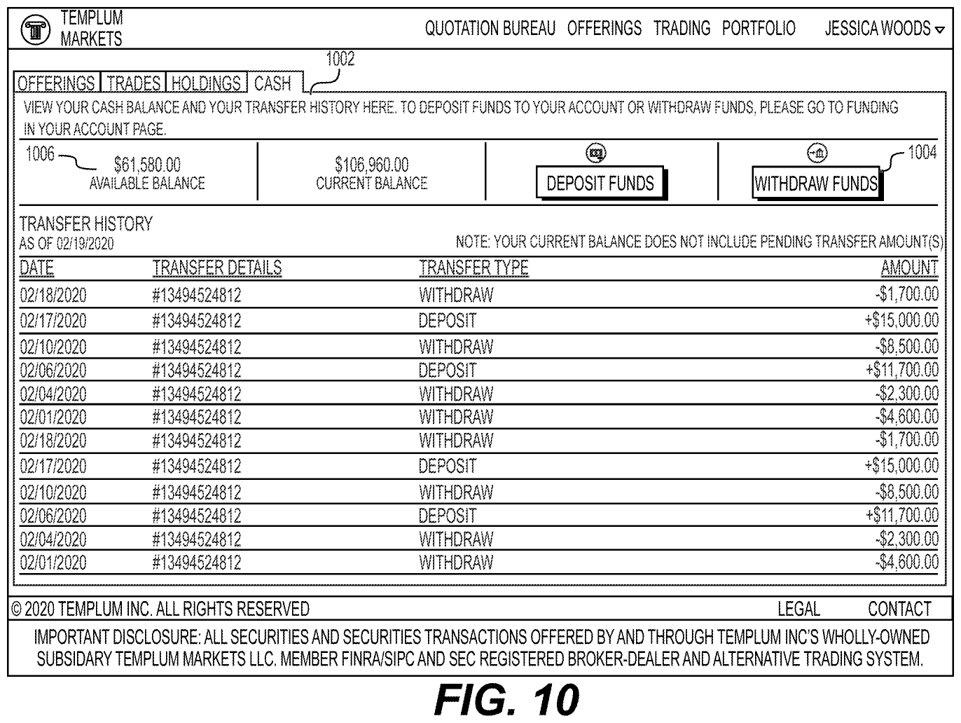

When configured to do so, the DAPS requires users to pre-fund accounts. This is facilitated by asking the user to link their bank account during onboarding. On the backend, this will connect their bank account to the custodian. When the user transfers money to their DAPS account, money moves from their personal bank account to a separate account held by the custodian. As depicted in FIG. 10, the amount in the custodian's account is displayed as “Current Balance” 1002. Users can withdraw funds 1004 from the custodian's account at any time up, except for funds reserved for open orders, unsettled trades, or pending withdrawals. The “Available Balance” 1006 amount that a user can withdraw=total cash balance−amount allocated to open orders and unsettled trades. A configurable “seasoning period” may be enabled to allow funds to be used for investing, but not available for immediate withdrawal.

When configured, users can only submit orders for amounts that are less than or equal to their cash balance (including the order fee). The DAPS, contemporaneously, runs the order through any other surveillance rules for the marketplace If the user does not have sufficient cash in their account, they will be prompted to fund their account before submitting an order. The ATS will prohibit users from submitting any orders that are greater than the amount that is in their cash balance. Once an order is submitted, that amount is reserved from withdrawal.

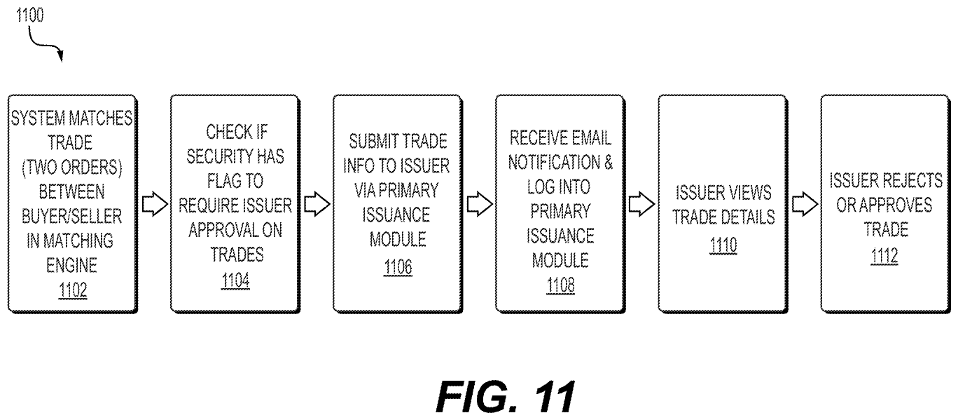

The settlement process for the ATS comprises issuer approval, execution of the PA, and custodian clearing and settlement. FIG. 11 depicts a flowchart showing the steps used for issuer approval 1100. First, the matching engine matches two corresponding orders in step 1102 which will become the executed trade. This event is the trigger for the entire settlement process.

During the security creation process, the administrator is required to select the issuer of the security and select flags to indicate if the issuer is required to approve trades or not. For each trade, a check is made in step 1104 if issuer approval is required or not. If approval is required, the settlement process proceeds to step 1106 in which the trade status is changed to “Pending Issuer Review.” The trade details are available to the issuer to review via the issuer module and a notification is generated in step 1108. The notification informs the issuer to log in to view and confirm the trade.

The issuer views the trade details is step 1110. In order to make an informed decision, the issuer is provided with complete details about the trade including Trade ID, Full names (first, last) of both counter-parties of the trade, indicating who is the Buyer and who is the Seller, name of security, symbol of security, company that the security is attached to, date and time of trade, price of trade, quantity (number of units) of the trade, and transaction history and holdings for both the Buyer and Seller (via drill down or in separate table).

Similar to that shown in FIG. 5, the issuer can choose to approve or reject the trade in step 1112. If reject is selected, the issuer is prompted to input a short description/reason for the rejection and submit the rejection. This cancels the trade in the ATS and updates the status of the trade to “Issuer Rejected.” Rejection of the trade may also generate a plurality of configurable notifications including an email to the buy to the Buyer with the rejection reason, details of the rejected trade, and date of the rejection; and an email to the Seller with the rejection reason, details of the rejected trade, and date of the rejection; and email to an administrator of the security, with the rejection reason, details of rejected trade, and date of the rejection. Each of these notifications is preferably provided when the corresponding user logs into the ATS.

If approve is selected in step 1112, a secondary pop up may be provided before submitting to confirm approval of the trade as final. This marks the trade as “Issuer Approved” and moves the trade to PA phase of the settlement process. If the security did not require issuer approval in step 1102, those trades also proceed to the PA phase of the settlement process.

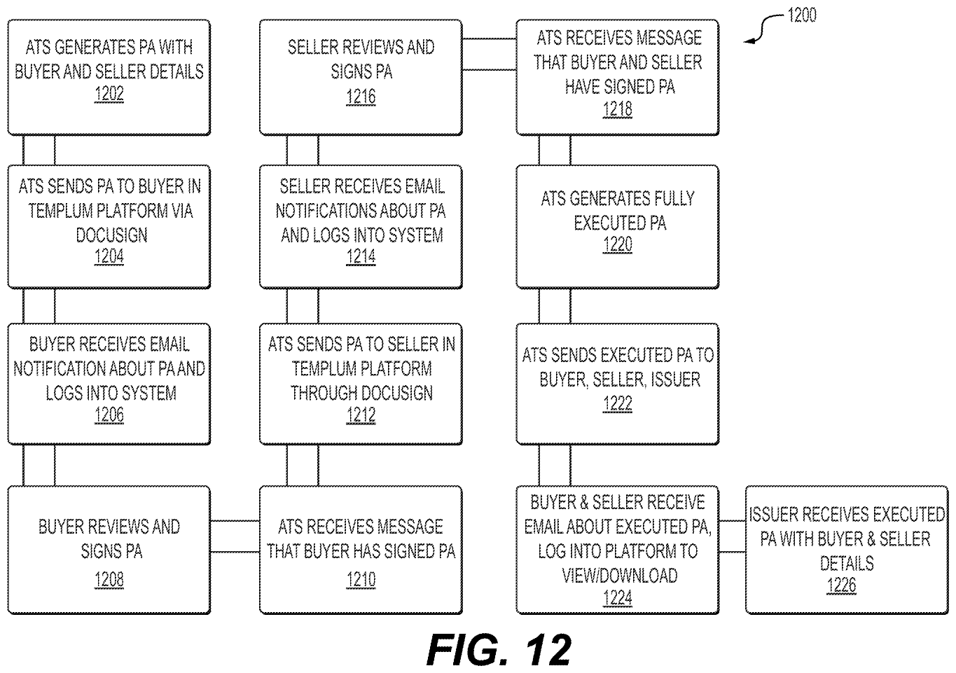

If the flag for Purchase Agreement required is active, the steps 1200 depicted in the flowchart of FIG. 12 are executed. The ATS generates the Purchase Agreement in DocuSign in step 1202, although other document execution platforms may be utilized. At a minimum, the PA includes details specific to the trade such as Buyer name, Seller name, date, time, price per share, quantity of shares, nominal value, and fees. Generation of the PA updates the status of the trade to “Pending Buyer PA Signature.”

The ATS first send the PA to the Buyer to sign in step 1204. The PA is sent within the so that the Buyer can log into the ATS and then navigate to view the PA. This should also generate an email notification to the Buyer with these details in step 1206 indicating trade details (trade ID, price, quantity, date, etc.), a request to log into the ATS to view and sign the PA, and details stating that the trade is not binding until both parties (Buyer and Seller) sign the PA and payment is complete. The notification may also include a disclaimer that if a signature is not received in a timely manner, the trade will be cancelled.

The Buyer then reviews and signs the PA in step 1208. The Buyer should be able to download the PA as well from this page. Execution causes updating of the trade settlement status to “Pending Seller PA Signature” in the ATS. The ATS also receives a notification that the Buyer has signed the PA in step 1210.

The ATS next sends the PA to the Seller in step 1212. The Seller receives a notification that a new PA requires signature in step 1214. The notification sent to the Buyer includes a message stating the PA has been signed by the Buyer, trade details (trade ID, price, quantity, date), a request to log in to the ATS to view and sign the PA, and a disclaimer that if signature is not received in a timely manner, the trade will be cancelled.

The Seller logs into the ATS and views the PA in step 1216 (modal within ATS that is DocuSign). The Seller should be able to download the PA as well from this page. The PA sent to the Seller will also include the Buyer's signature entered in step 1208.

Once the Seller signs the PA, the ATS receives a message with this action in step 1218. The PA in DocuSign is updated to now include the Seller's Signature and date/timestamp. This updates the trade settlement status to “Pending Buyer Payment” in the ATS. The ATS then generates the fully executed PA in step 1220 and applies any relevant security settings (password protection, alteration settings, permissions, etc.).

The fully executed PA is sent to the Buyer, Seller, and issuer in step 1222. This action should also generate an email notification to the Buyer and Seller in step 1224. The Buyer and Seller each receive a notification indicating trade details (trade ID, price, quantity, date), that both parties have counter-signed the PA, date of signature by each party, and a link to log into ATS to view documents.

The issuer that is assigned to the security that is the subject of the trade receive a notification indicating that a transaction was executed between Buyer & Seller, trade details (trade ID, price, quantity, date), date of signature by each party, link to log into ATS to view documents.

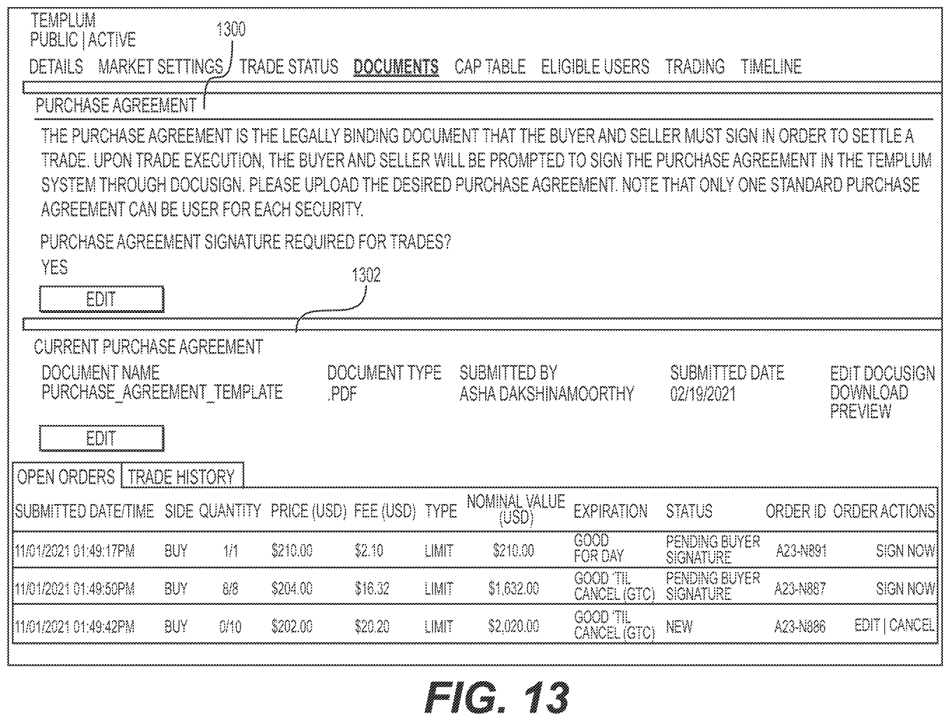

FIG. 13 depicts a Purchase Agreement screen 1300 in which the issuer can view/review all purchase agreements 1302 executed for a particular security. As indicated, only one standard PA is preferably used for each security to ensure consistency.

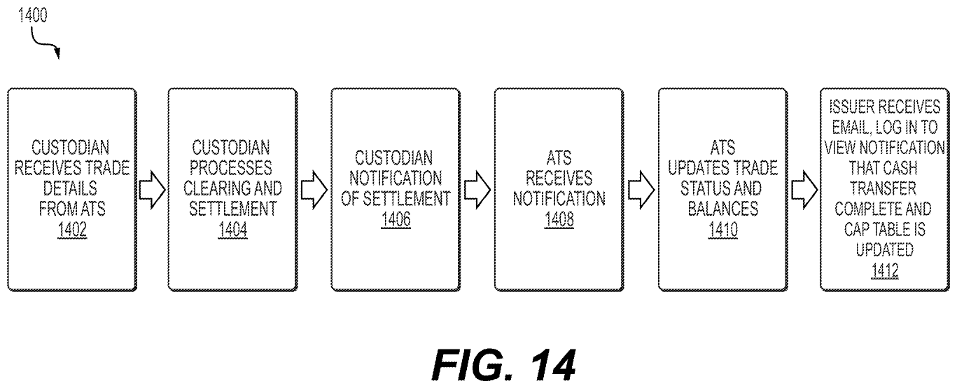

FIG. 14 depicts a flowchart showing the steps 1400 used for custodian clearing and settlement for all approved trades of securities. The custodian receives trade details in real-time from the ATS to process clearing and settlement of the trade in step 1402. The trade details include Buyer name and identifying details (brokerage account ID, email, etc.), Seller name and identifying details (brokerage account ID, email, etc.), Security name, symbol, and ID, trade price, Trade quantity, nominal value of the trade, and fees.

The custodian will then process and settle the trade in step 1404. This process includes the transfer of funds from the Buyer brokerage account to the Seller brokerage account, transfer of securities from the Seller brokerage account to the Buyer brokerage account, and deduction of fees from both Buyer and Seller brokerage accounts and transfer to the ATS account held at the custodian. The Custodian sends a message confirming clear and settlement has been completed for the trade in step 1406. Each Investor's cash and securities balances should be updated in their brokerage account. The Custodian also sends a trade confirmation directly to the Buyer & Seller through the DAPS system.

The ATS receives a notification that the settlement has been processed in step 1408 directly from the Custodian integration. The ATS updates the trade status to “Settled” in step 1410. The Buyer's and Seller's cash and securities balances (reconciled with custodian) are updated, and the cap table for the security is updated to reflect the finalized trade.

The issuer receives a notification in step 1412 stating the trade details (trade ID, price, quantity, date), that cash has been transferred from the Buyer to the Seller, that the trade is now fully settled and complete, and that the cap table has been updated to reflect this trade and can be viewed by the Issuer.

Quotation Bureau Module (OB) & Qualified Matching Service (OMS)

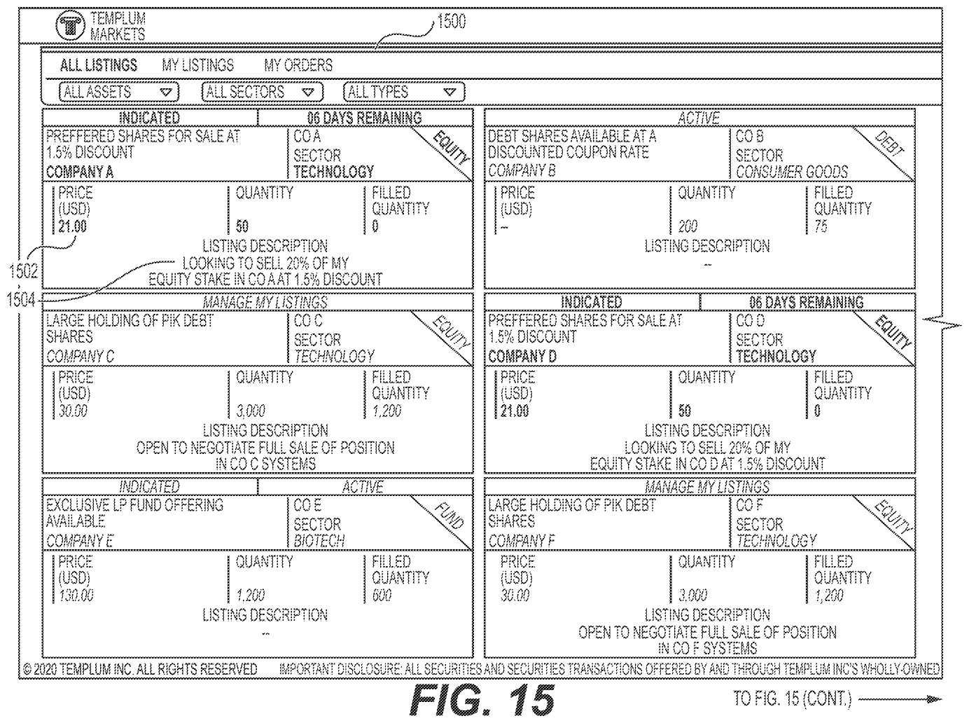

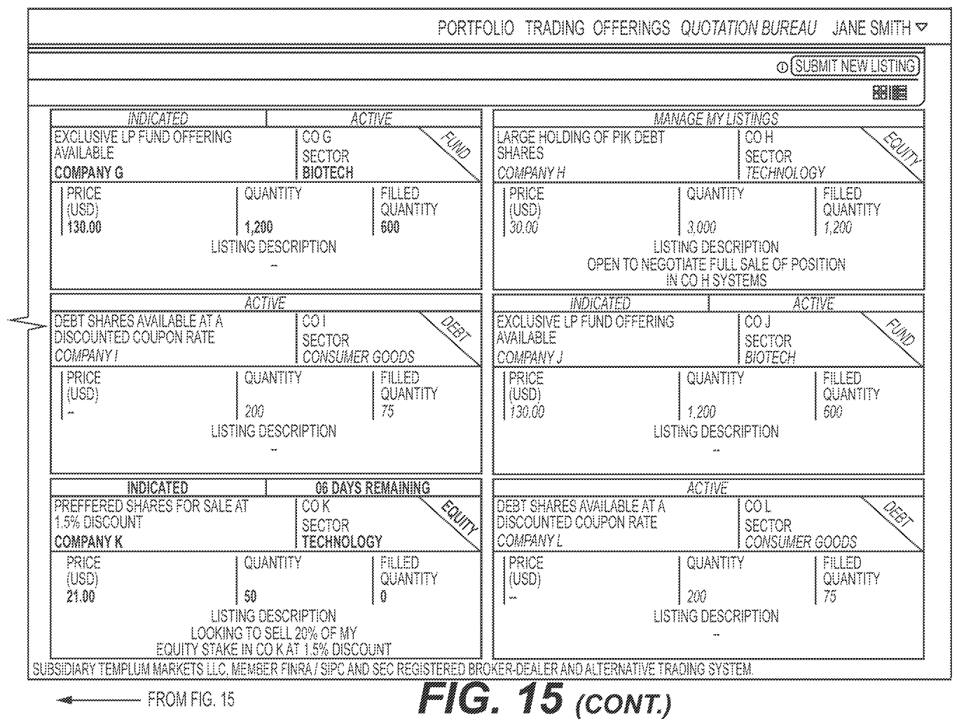

A unique feature of the DAPS not found in other trading platforms is the ability for Buyers and Sellers to anonymously negotiate a trade of securities. FIG. 15 depicts an example quotation bureau page 1500 showing postings of shares by Sellers for existing investments. A bulletin board style is preferably utilized so that each offering is distinct and they can be searched or filtered easily. For example, the first listing 1502 is for UBRT and expires in six days. The Seller may be able to include a listing description 1504 indicating a reason for the sale and the quantity and price of shares being offered.

Buyers submit non-binding indications of interest for each offer and can negotiate directly with the Seller. All offers may be subject to approval by the Issuer. The QMS ensures that both the Buyer and Seller meet all requisite compliance restrictions for the sale.

Listing Posting

All Investors for the QB go through the same onboarding process to ensure that they are approved or denied access to certain issuances or trades. Non-accredited Investors can generally only access securities under Reg A+. Self-certified accredited Investors can access securities under Reg A+, Reg D 506(b), REITs, and CF securities (e.g., using a 30 day hold). Verified accredited Investors can access securities under Reg A+, Reg D 506(b), and Reg D 506(c). The 30 day hold discharges a “get to know you” requirement within the securities regulation. This time period can be adjusted if required.

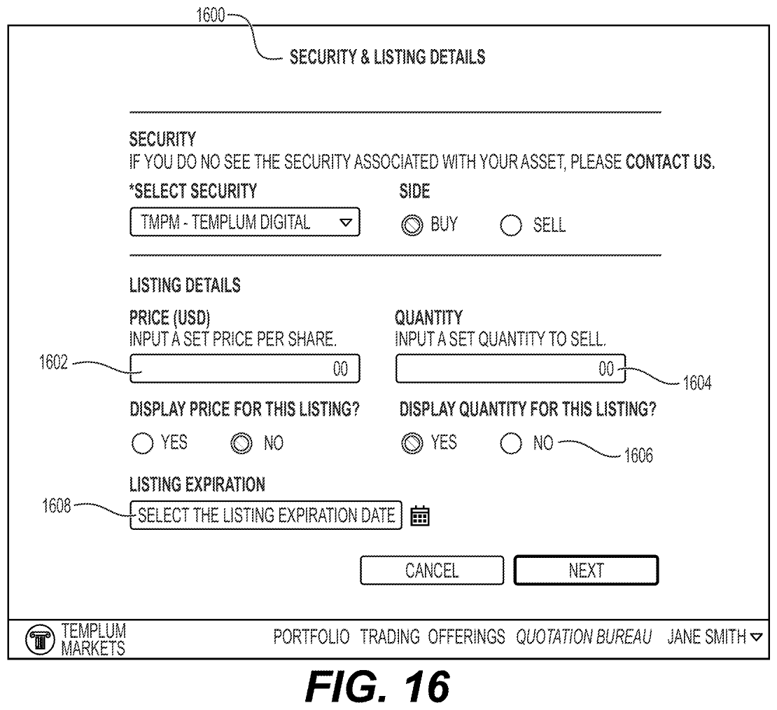

In the context of the present invention, listings are the individual buy or sell postings that a user submits for a particular security that are publicly displayed as shown in FIG. 15. Investors can create a buy or sell listing for a security. A sample screen used by an Investor to create a listing 1600 is depicted in FIG. 16. As shown, the creation of a listing requires selection of buy or sell price 1602, quantity 1604, display price: yes or no (enables the Investor to hide the price from the public listing), display quantity: yes or no (enables the Investor to hide the quantity from the public listing) 1606, and expiration date 1608. Once an Investor has published a listing, it is posted to the QB for all other Investors to view. Investors can close listings at any time.

In a preferred embodiment, Investors can only create one listing per security. If a listing is past the expiration date, it is removed from the market, and no Investors should be able to view it or submit indications against it. Creating a listing checks the Investor's cash or securities balances to ensure they are good for the transaction.

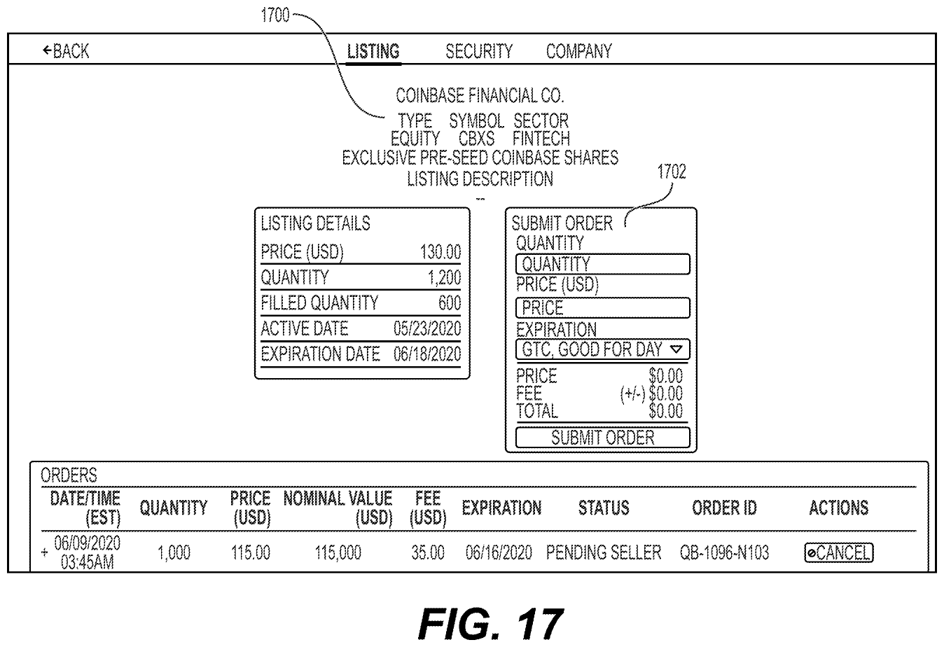

As shown in FIG. 17, Investors can submit indications for a specific listing 1700 to demonstrate interest in the listing and begin the transaction process. Indications can only be submitted for open listings. To submit an indication 1702, the Investor must input quantity, price, and expiration. Indications are not publicly published to the QB for other Investors to view. Only the listing creator can view the indications. The listing creator receives a notification when an indication has been submitted for their listing. The listing creator can view all indications in the QB.

Investors can only create one indication 1702 per listing. Creating an indication 1702 checks the Investor's cash or securities balances to ensure they are good for the transaction Investors can cancel indications at any time. If an indication is past the expiration date, it is marked as Expired or Cancelled. The Investor that created the listing should not be able to accept/reject/counter it.

Negotiation Between Buyers and Sellers

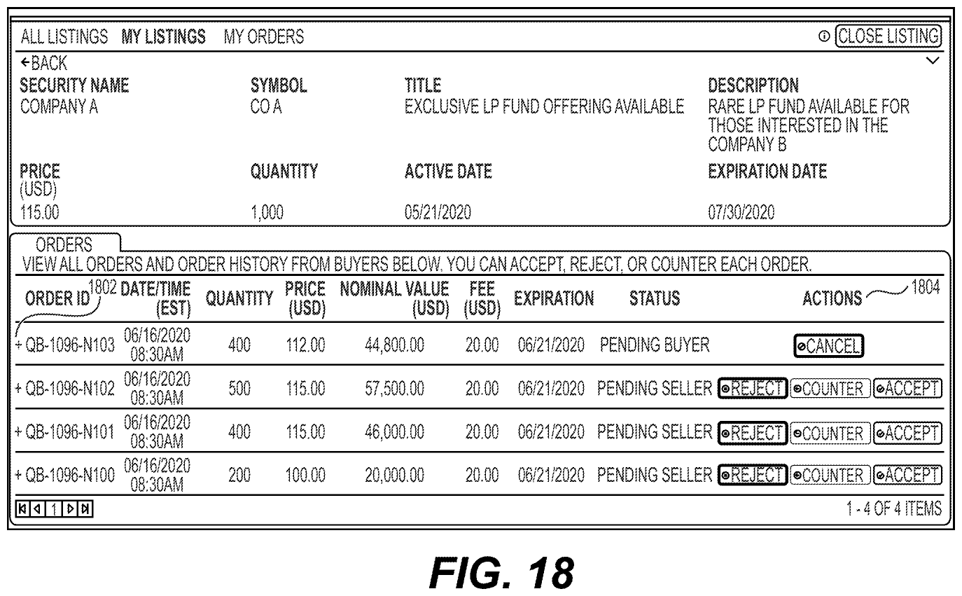

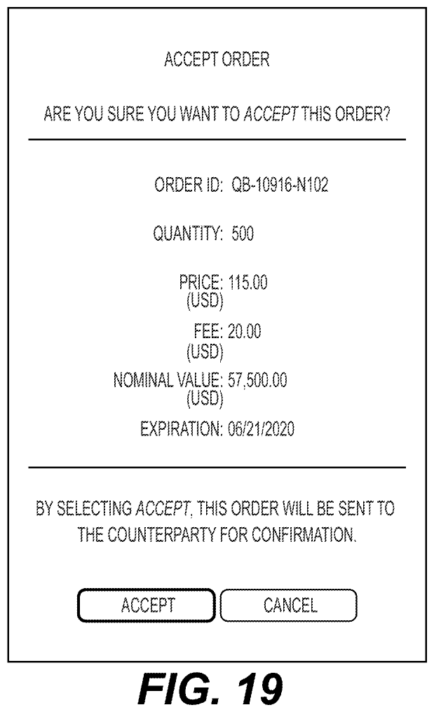

The listing creator can review all received indications 1802 in the platform as shown in FIG. 18. For each indication, they have three actions 1804 available: accept, reject, or counter. Accepting an indication will create a matched trade between the Buyer and Seller. Accepting an indication causes a secondary window 1900 to preferably be displayed as depicted in FIG. 19 to confirm acceptance. This trade will then move through the same settlement process as already described. When accepting an indication 1802, checks will be done for both user's cash and securities balances. If the balance is insufficient, the transaction will be rejected

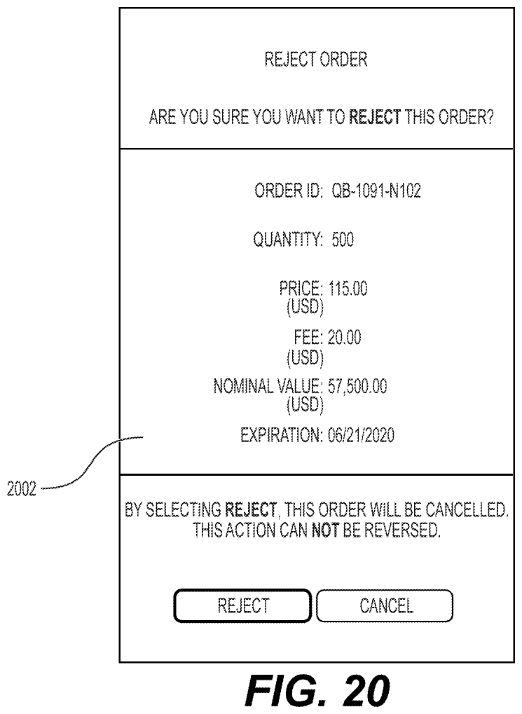

Rejecting an indication will cancel the indication. The listing will remain open until closed by the Seller. Rejecting an indication causes a secondary window 2002 to preferably be displayed as depicted in FIG. 20 to confirm the rejection.

With the counter feature, the listing creator can send a counter indication to the investor that submitted the indication. All negotiations through the counter indication process are anonymous.

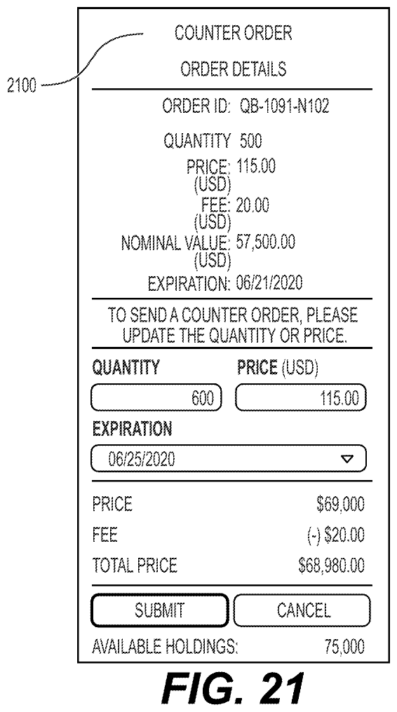

To create a counter indication, the user will need to submit a price, quantity, and expiration date through a counter order screen 2100 as depicted in FIG. 21. The Investor that created the original indication will receive an email notification of the counter indication. This Investor also has the opportunity to accept, reject, or counter the indication until both parties reach an agreed transaction.

All negotiation history is stored and displayed, so each Investor can see the full interaction with a single counter-party. The listing creator can accept multiple indications and negotiate with multiple counter parties at once.

Configurable Workflows

The QB enables the workflow for broker dealers, issuers, or marketplace operators to approve each listing before it is made publicly available for Investors. The workflows can be modified in a customized manner or process based on client needs and wants. For each offer or indication, the investors eligible to participate can be customized using information obtained during the onboarding process. Banking or payment providers can be integrated to enable instant settlement, where cash is transferred directly upon trade settlement. Further, DocuSign integration enables electronic agreement signature by buyer, seller, and issuer for transactions conducted on the platform.

QMS

The QMS operates on the same platform as the QB with compliance restrictions. The QMS allows for trading of Limited Partnership Interests up to 10% of outstanding interests per annum. The selling LP must enter into a binding agreement to sell the interest 15 calendar days after the date the interest is listed for sale to potential buyers. The issuer may require the selling LP to provide proof of ownership to be eligible to list. The sale closes 45 calendar days after the listing is made available to potential buyers. If the interest is not sold, the selling partner's information is removed from the matching service within 120 calendar days. The LP can relist their interest 60 days after the original listing was removed.

ATS/OB Interaction

Orders generated initially on the ATS can be moved as a single order or a bulk order to the Quotation Bureau for execution through a peer-to-peer mechanism.

Issuer Module/Platform

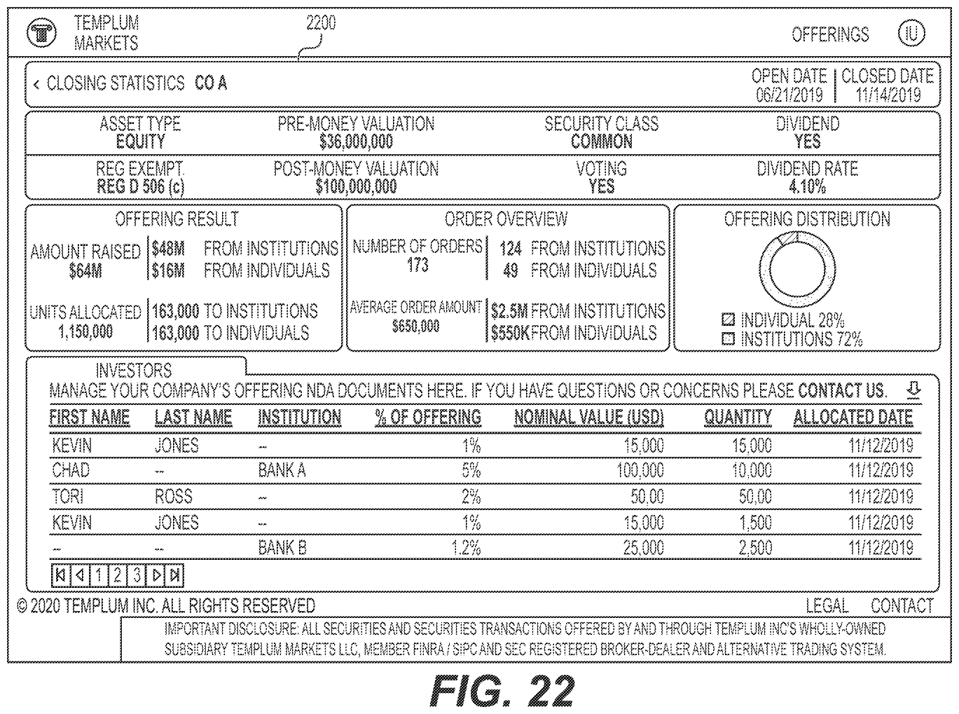

The issuer module provides an administrative portal for deal tracking, cap table management, and deal closing. An example screen 2200 of the issuer module is depicted in FIG. 22. The issuer module allows deals to be tracked. Primary issuance, fundraising status, orders, and allocations can all be viewed from the same screen 2200. The issuer module also allows issuers to countersign documents and allocate shares.

The issuer can view real-time and historical investor breakdown for primary issuances and securities trading in the secondary marketplace. The issuer module allows viewing of trading activity for securities, approval of trades to comply with right of first refusal (ROFR) requirements, and management of eligible investors for trading.

Deal Tracking

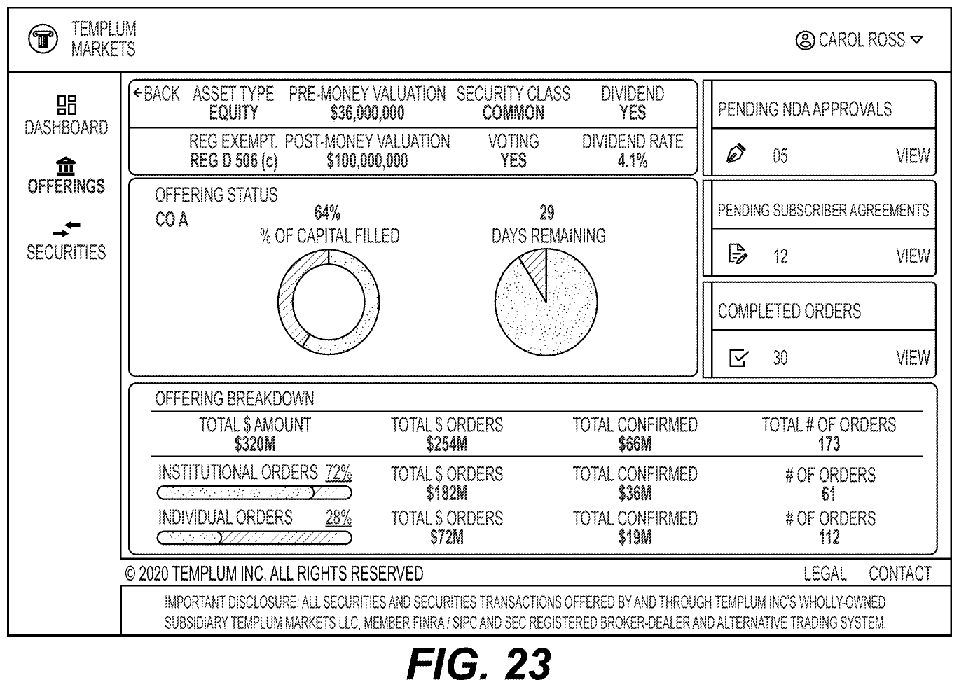

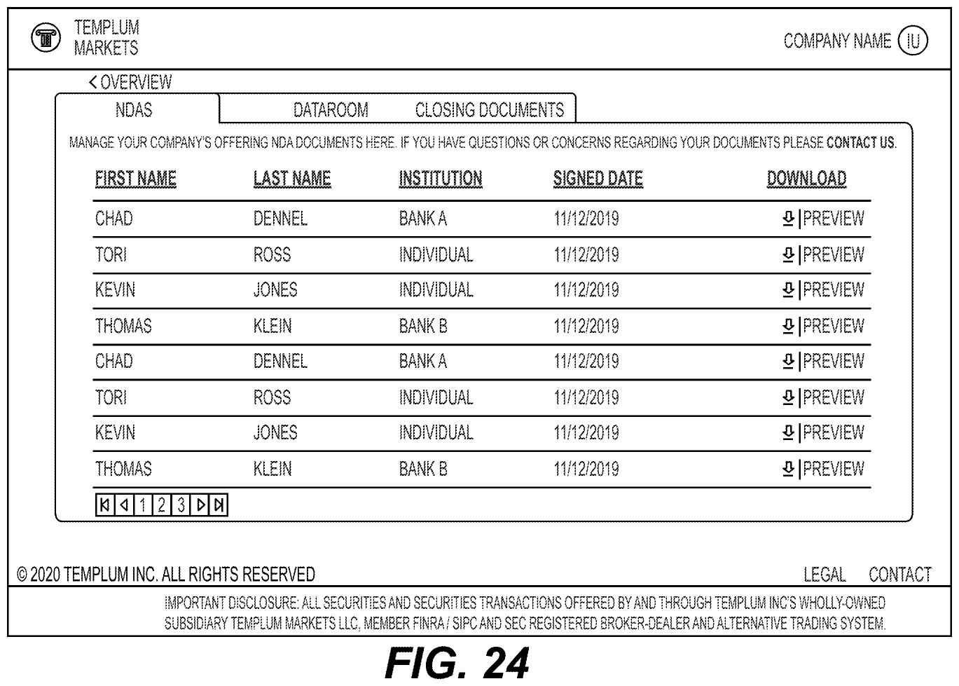

The issuer platform allows for the tracking of primary issuance as depicted in FIGS. 23 and 24. The issuer can track days remaining and deal data in a streamlined dashboard, view metrics on amount of capital filled, number and size of orders, and types of investors between individuals and institutions.

DocuSign integration enables seamless electronic signature of subscription documents. Issuers are notified as soon as an investor signs the document, significantly reducing time and effort in a manually intensive process. After payment receipt, the issuer can allocate shares to investors directly in the issuer platform, which will then appear in the investors' portfolio holdings.

Cap Table Management

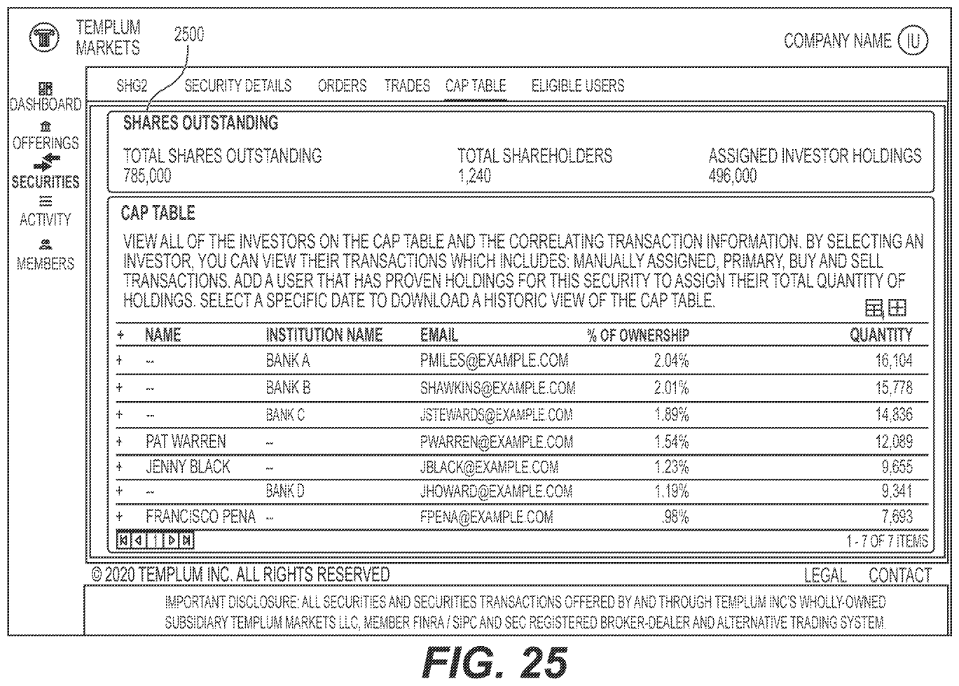

The issuer module can be used to manage dynamic cap tables 2500 for assets through primary issuance and secondary trading as depicted in FIG. 25. The cap table 2500 is automatically updated based on settled trades (secondary market via ATS) and allocated orders (primary issuances). The cap table 2500 includes a breakdown of institutional, individual, and employee holdings, top 5 investors, and other key metrics. A historic cap table can automatically be generated for any desired date range.

Trade Management

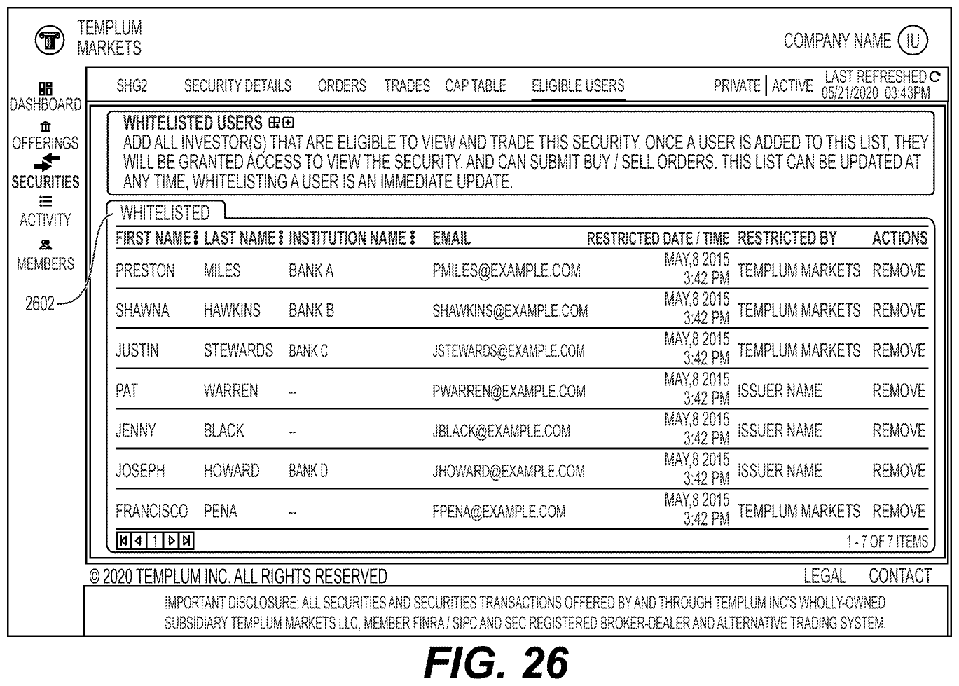

The issuer module also provides the capability for issuers or their agents (e.g. Transfer Agents) to approve trades and manage investors for assets available in the ATS and/or QB. A whitelist or blacklist 2602 of investors can be managed for each security by issuers as depicted in FIG. 26.

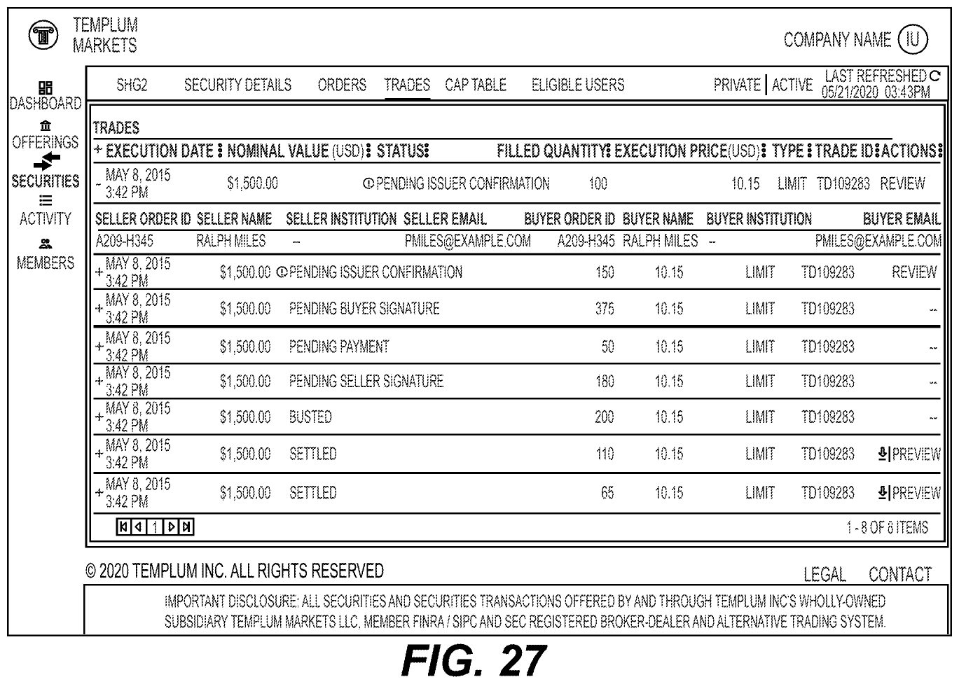

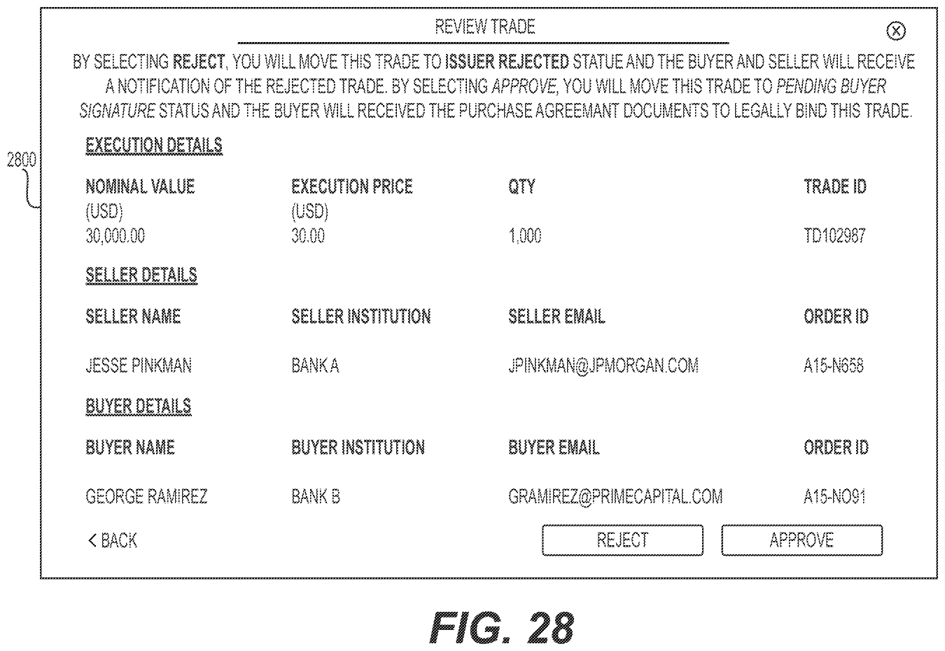

Issuers can view all open orders and executed trades for each security trading via the Quotation Bureau screen or ATS as shown in FIG. 27. For securities that offer a right of first refusal (ROFR), issuers can approve trades 2800 on a case by case basis as depicted in FIG. 28.

DAPS and Agent Administration

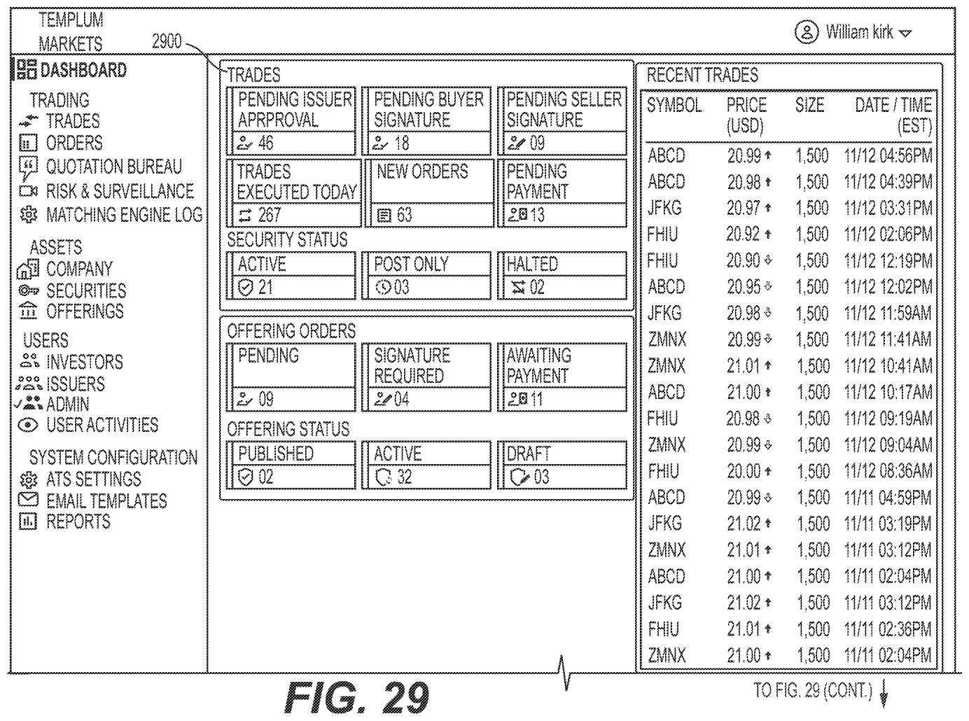

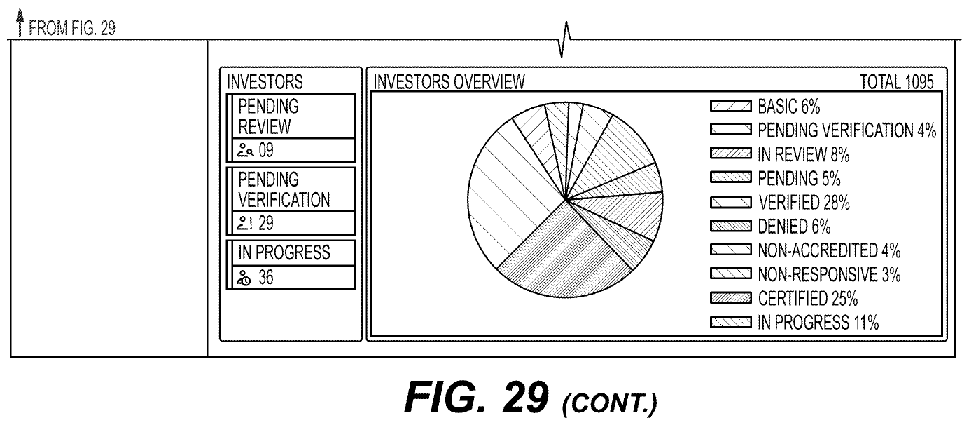

The various tools and features of the present invention for Buyers, Sellers, and Issuers have been described. In addition the DAPS provides an administrative platform that allows licensed representative to manage client marketplaces. The administrative platform allows for customization and management using a user-friend UI. An example home screen 2900 for the administrative platform is depicted in FIG. 29. The administrative platform provides direct links to all items needing addressing such as trades pending review, offers pending, signatures awaited, etc. Through the administrative platform, the system administrator can set up and manage investors, offerings, securities, orders, trades, issuers, and reports.

Investor Administration

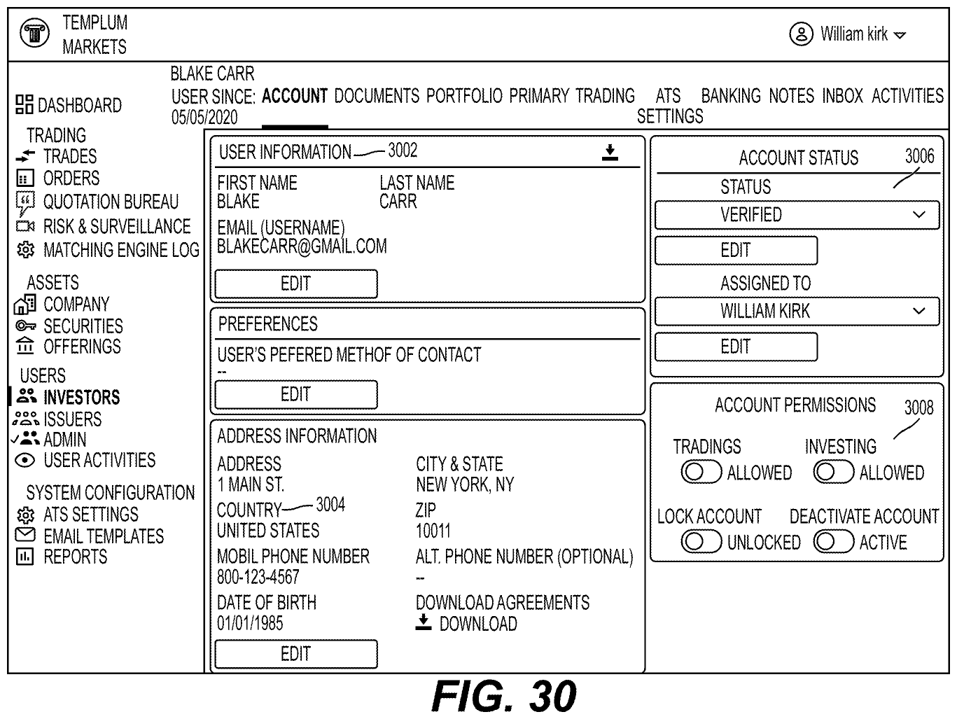

The administrative platform can be used to create, approve, and monitor investor accounts, status and investment eligibility. For example as depicted in FIG. 30, the information about the investor can be modified such as user information 3002, address information 3004, account status 3006, and account permissions 3008. The administrative platform can further be used to view and manage investor portfolio, view and download all investor platform activity to understand investor engagement, manage and download investor documents from onboarding, as well as documents executed in the platform such as NDAs or subscription documents, create and manage institutional accounts and assign individual investors, and, for institutional investors, manage sub-user investment permissions.

Offering Administration

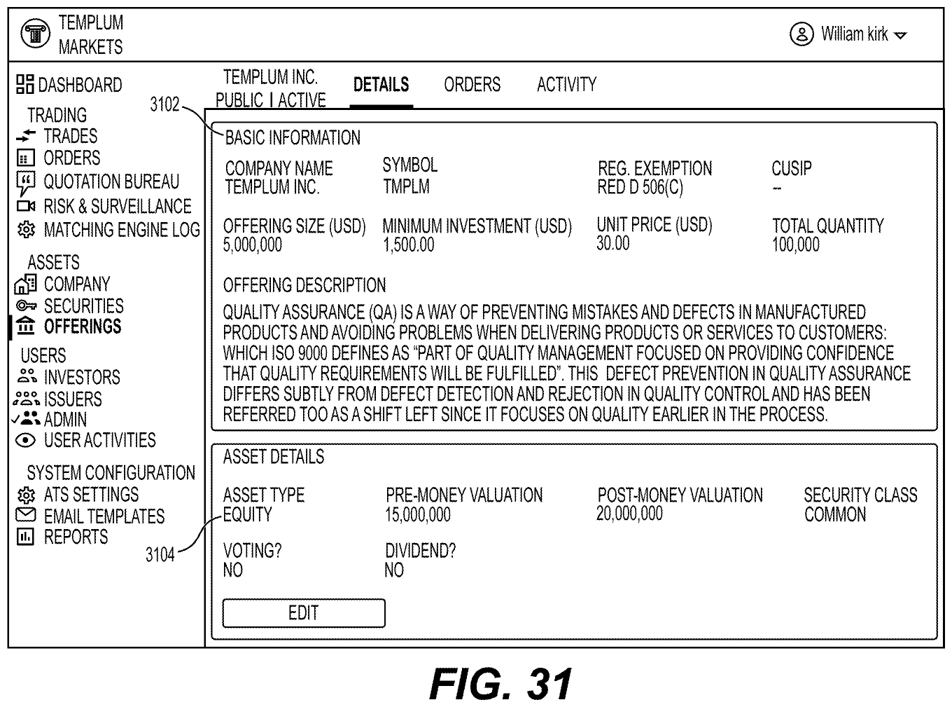

The administrative platform lets system administrators create primary issuances, monitor deal activity, and confirm orders. For example, the basic information 3102 or asset details 3104 of any issuance can be edited as shown in FIG. 31. Details such as asset type, regulatory exemption, minimum investment, quantity of shares available, and unit price can be added. Further, the information can be updated to include financial data about the deal including pre/post money valuation, dividends, voting, yield to maturity, interest, etc. Custom fields can even be added to each issuance.

The administrative platform can also be used to upload documents to the data room and add in a third-party data room URL. As previously described, the administrative platform can be used to manage, confirm, allocate, or reject orders and mark trades as closed.

Security Administration

Like primary issuances, the administrative platform can also be used to enable secondary trading in ATS by creating securities and defining market parameters. For each security, buyer, seller, and minimum fees can be established for each security. The security's states can be updated at any time to halt, post-only, or in active. If required, add a purchase agreement for the security and other documents for settlement can be added via the administrative platform.

Quotation Bureau Administration

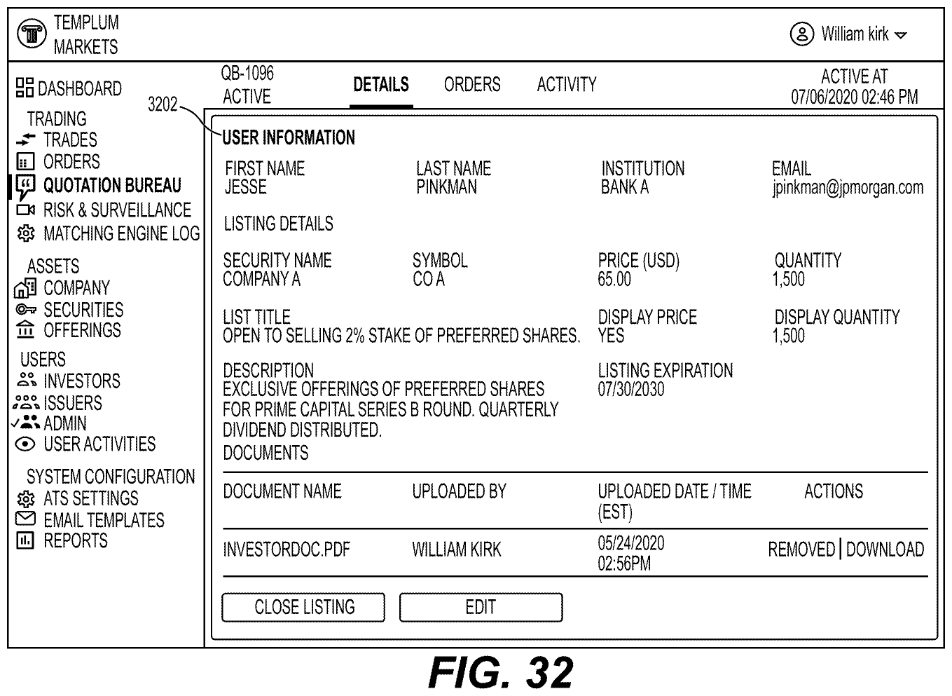

The administrative portal includes complete tools to manage listings and orders in the Quotation Bureau. As depicted in FIG. 32, the complete information for each listing 3202 can be approved and edited using the administrative portal before or after the listing is approved. Listings can be monitored and orders can be canceled as needed. Further, the administrative portal allows for the creation of listings on behalf of investors

Cap Table Administration

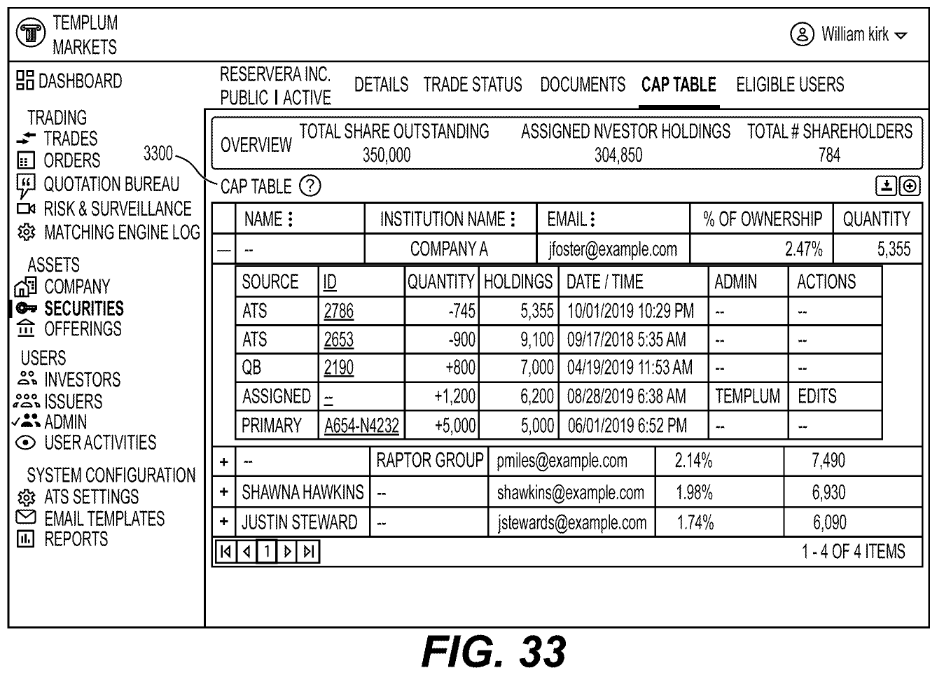

Regardless of if the asset is trading in the quotation bureau, the ATS, or is raising capital through the primary offering work flows, comprehensive cap table management tools are available for administrators and issuers for the asset using the administrative portal 3300 as depicted in FIG. 33. The administrative portal can be used to add investors and grant shares at any time, with the ability to back-date the grant date, expand each cap table entry to see all transactions and grants for every investor or institution, and download the historical cap table for any prior date in time for convenient reporting for compliance and audits.

ATS Market Administration

The administrative portal allows for the setting of market hours and a post-only scheduler at the security level or globally within a given environment. The ATS provides the ability to schedule trading and post-only sessions for securities on its ATS Trading days/hours indicate when the matching engine is active and live trading is active.

Post-only days/hours indicate when orders can be submitted and received for a security.

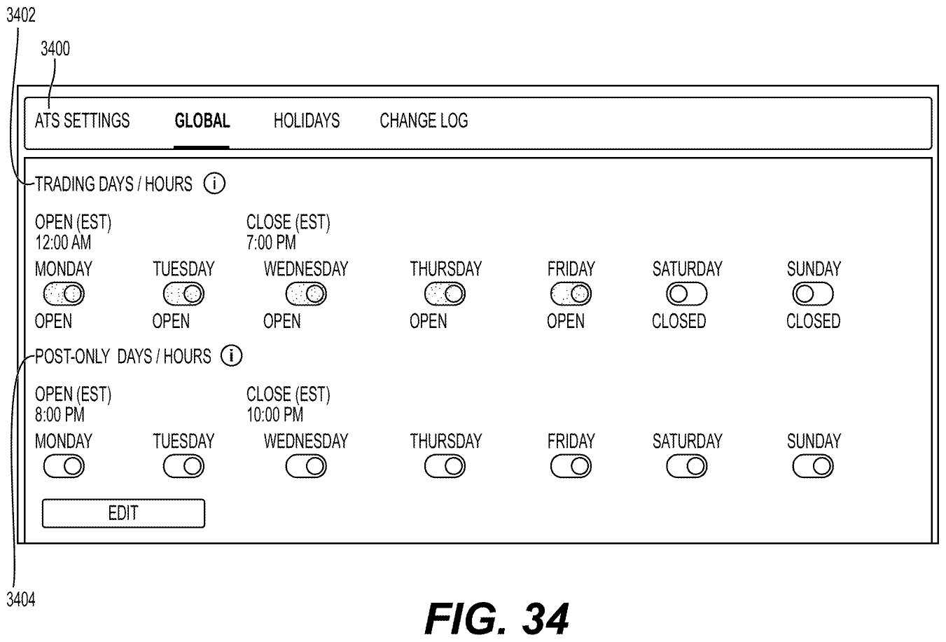

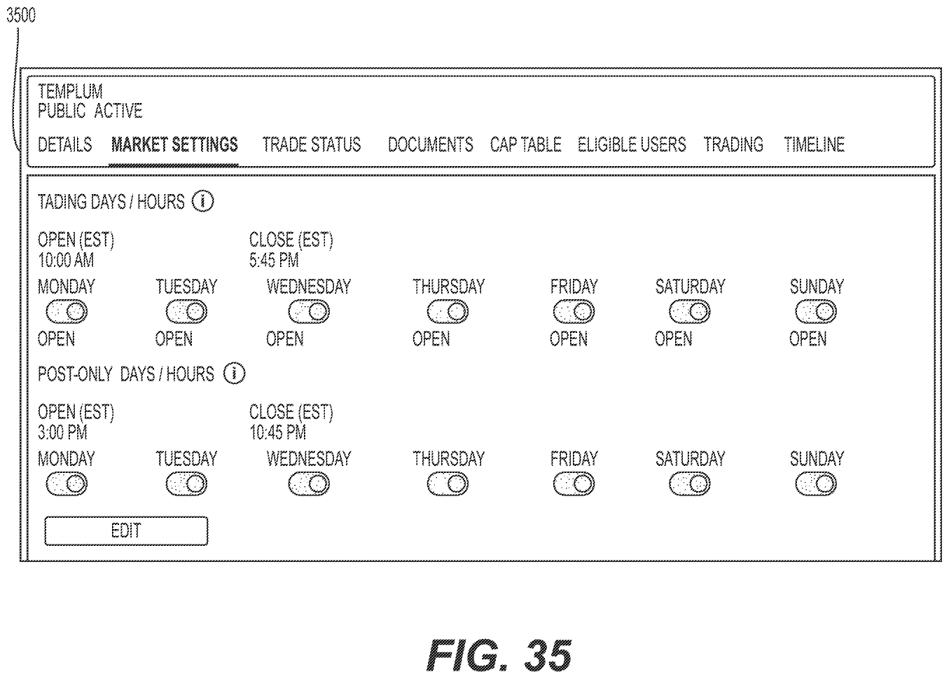

Matching through the matching engine will not occur during the post-only period. Orders submitted during the post-only period will be matched and executed (based on best price, time) at the opening of the trading period. Trading and post-only periods can be set for both an individual security as well as for all securities in the ATS (global). FIG. 34 depicts a sample ATS setting screen 3400 in which the trading days/hours 3402 and post-only days/hours 3404 are set globally and FIG. 35 depicts a setting screen 3500 that can be used for each security.

Globally set holidays, including partial days (½ days), take priority over trading hours/days set for a security. For example, if trading day for a security is set as every Friday, but Friday, July 3 is set as a partial holiday, trading will not be available for the security on Friday, July 3 after the holiday takes effect.

If unique Trading Days and Hours are not specified for a security, the Global ATS Trading Days and Hours apply Default settings for Trading Days:
Monday (default ON)
Tuesday (default ON)
Wednesday (default ON)
Thursday (default ON)
Friday (default ON)
Saturday (default OFF)
Sunday (default OFF)

The post-only schedule provides the capability to set days/times that post-only window is invoked on a specific security if post only is turned on for a day, the administrative portal first validates that that trading hours are within the post-only range. The post-only should be the wider time range of the two. When market hours are set, they will take priority For example:
Market hours—Tuesday, 9:00 AM-4:30 PM
Post only hours—Tuesday, 12:00 AM-11:45 PM

If post-only is not set for the day, market hours are in effect and post only should not be considered. The post-only schedule is also available for global markets, but security specific settings take priority. When post-only is active, buy and sell orders can be submitted for the security but no trades will be matched and executed. When the trading hours take effect, any orders received during post-only will be processed in the matching engine and matched and executed based on time/best price.

Surveillance and Monitoring

The ATS is provided with a surveillance and monitoring engine to enforce compliance in the market place. The administrative portal can be used to configure rules, at a security level or globally within an environment, based on trades or orders executed, whether that is based on the order size (absolute or percent of outstanding), trade value, price, price differential based on last trades, and so forth. Rules can be triggered to alert specific parties, such as a broker dealer team or to halt a market.

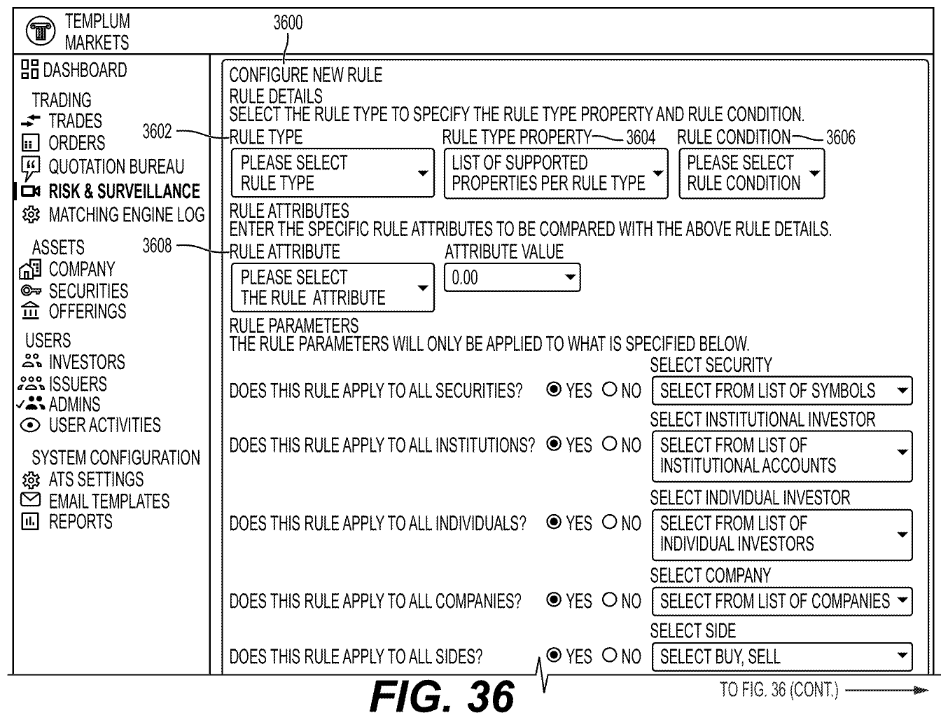

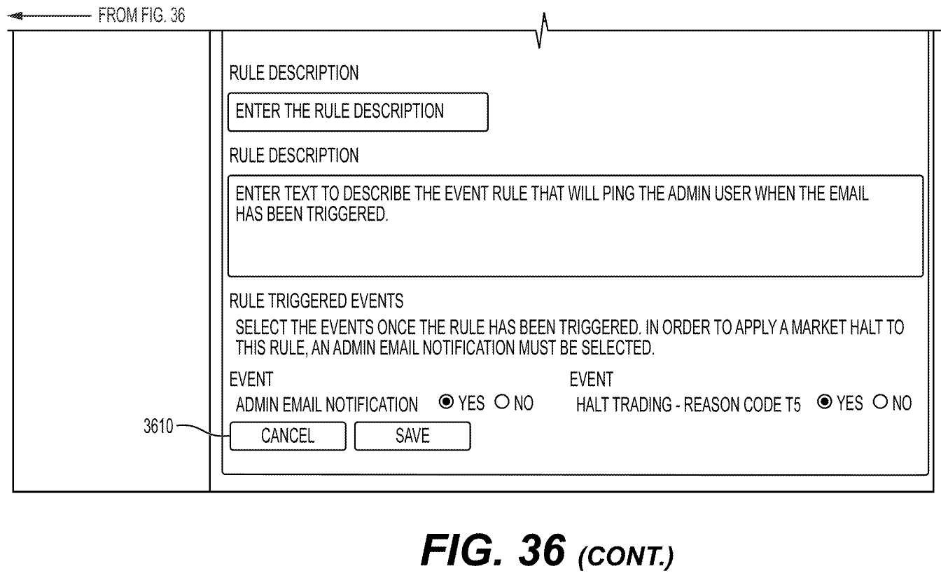

FIG. 36 depicts an example of a screen 3600 used to create a new rule for surveillance and monitoring. When creating a rule, the following details can be specified:

1. Rule Type 3602

a. Trade—surveillance based on executions (Trades)

b. Order—surveillance based on orders

c. Quote—surveillance based on quotes

d. Cache—surveillance based on cached data

e. Validation—validation rule to reject orders that violate the rule. This rule type will block orders before they are submitted to the matching engine

2. Rule Property 3604—The specific property that the rule will be based on

a. Price

b. Average Price

c. Last Quantity

d. Last Price

e. Cumulative Quantity

f. Order Quantity

g. Nominal Value

h. Cumulative Nominal Value

i. Close Price

3. Rule Condition 3606—specifies how the rule will be implemented

a. Equal

b. Great

c. Greater or Equal

d. Less

e. Lesser or Equal

4. Rule Attribute 3608—Field to compare Rule Property to. If no comparison is desired, can be left blank

a. Last size

b. Last Price

c. Previous size

d. Previous price

e. Bid Price

f. Bid Size

g. Ask Price

h. Ask Size

i. Outstanding Shares

j. Total Volume

k. Daily Volume

l. Weekly Volume

m. Monthly Volume

n. Yearly Volume

o. Volume Previous Day

p. Volume Previous 5 Days

q. Volume Previous 25 Days

r. Total Notional Value

s. Daily Notional Value

t. Weekly Notional Value

u. Monthly Notional Value

v. Yearly Notional Value

w. Notional Value Previous Day

x. Notional Value Previous 5 Days

y. Notional Value Previous 25 Days

z. Close Price

5. Attribute Value—value that will trigger the rule condition

6. Description—description of the rule

7. Text—any additional text for the rule. Will be included in email notifications.

8. Security—select which security the rule applies for, or select ‘all’, which will apply to all securities

9. Issuer—select which issuer the rule applies for (which will then apply the rule to all issuer related securities), or select ‘all’, which will apply to all issuers

10. Institutions—select which institutional investors the rule applies for (which will then apply the rule to all orders submitted by users of that institution), or select ‘all”, which will apply to all institutions

11. Individuals—select which individual investors the rule applies for, or select ‘all’, which will apply to all individuals

12. Side—select which side to apply the rule to (buy or sell), or apply to both

13. Actions 3610—available actions when the rule is triggered:

a. Email notification—admins to receive an email alert

b. Halt trading—halt trading for the security

c. Freeze investor—freeze the investor account

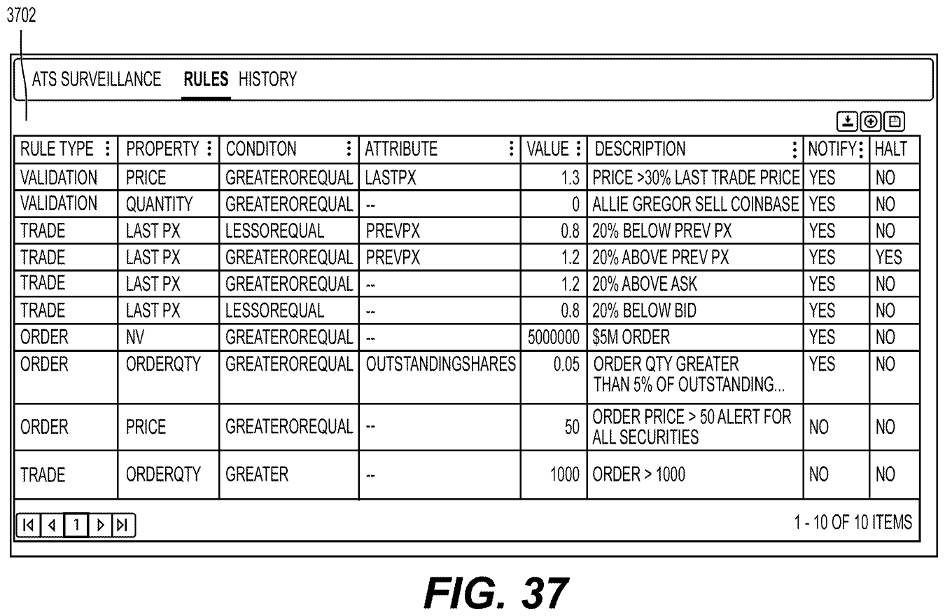

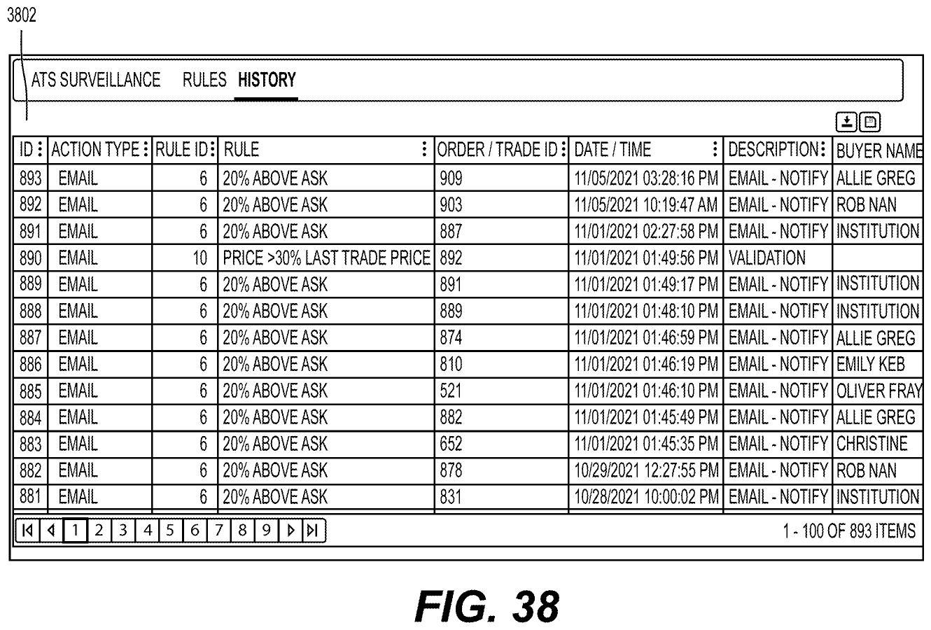

The administrative portal provides a full listing 3702 of all rules as shown in FIG. 37. From this screen, the details about any rule can be reviewed and/or edited. A full history of all actions 3802 generated by the rules is depicted in FIG. 38. The user can see the results of any rules that have been triggered and the corresponding action that was taken (email, trade halt, etc.).

Order Administration

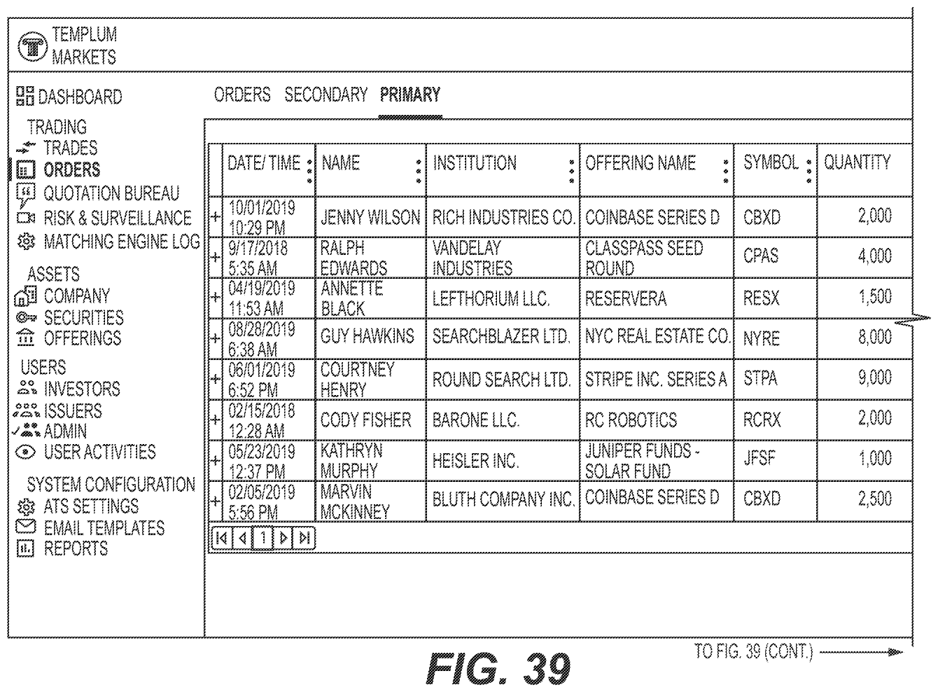

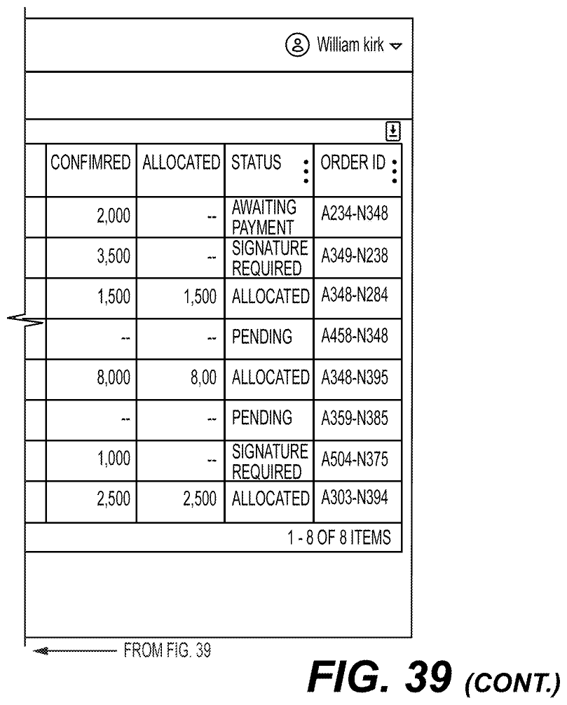

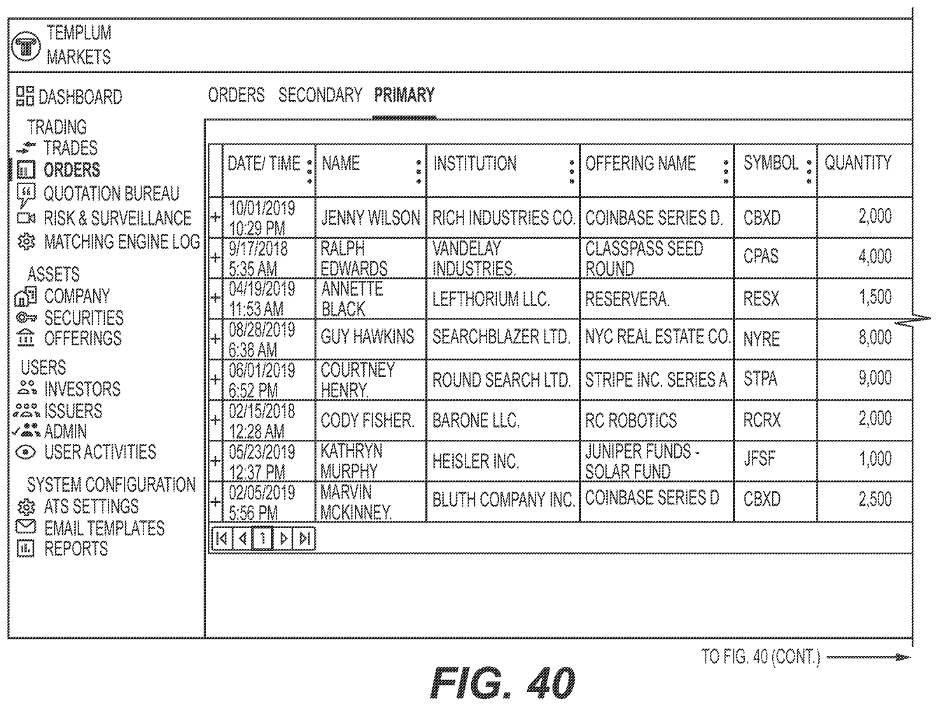

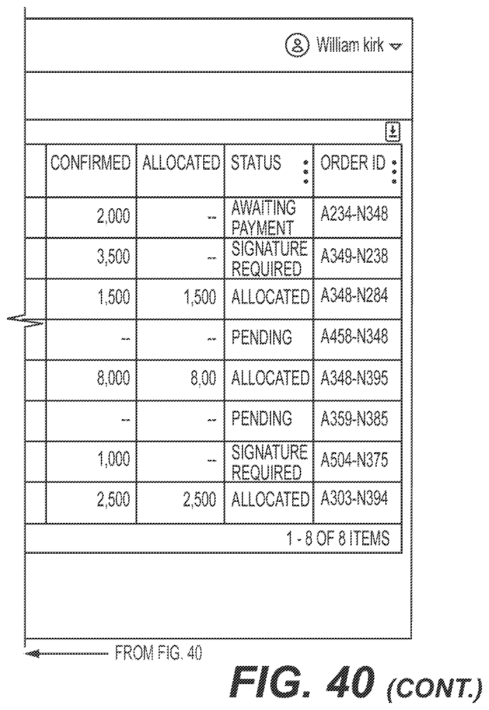

The administrative portal provides a robust order blotter for primary and secondary markets as depicted in FIGS. 39 and 40. The order blotter provides an audit trail of all order activity including edits and cancellation. For primary orders, option confirm and allocate on behalf of issuer, execute documents and monitor payment are provided. Orders can bel canceled on behalf of investors or created in the interface.

Trade Administration

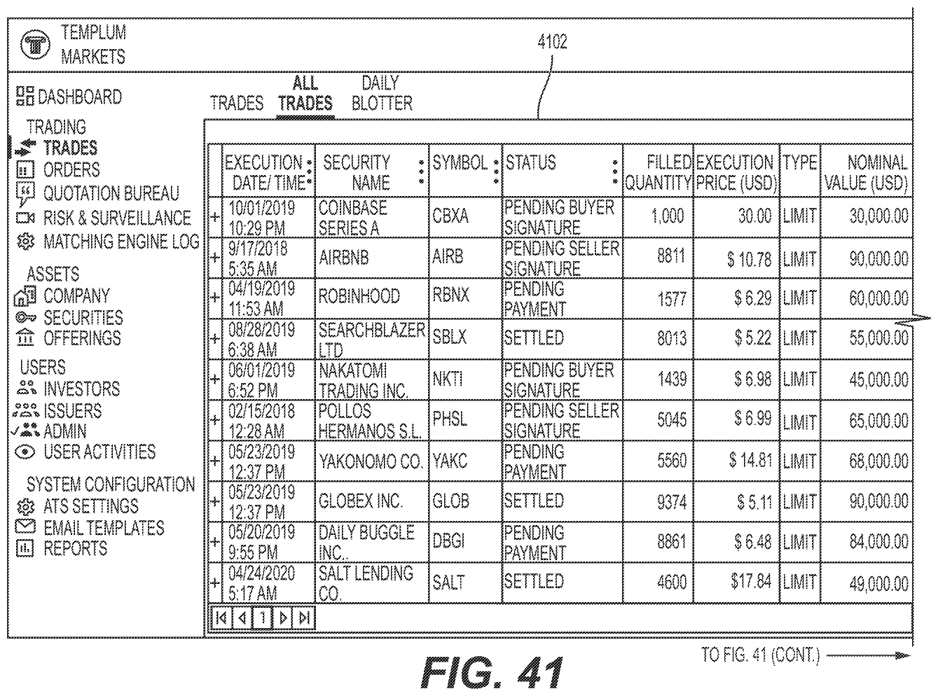

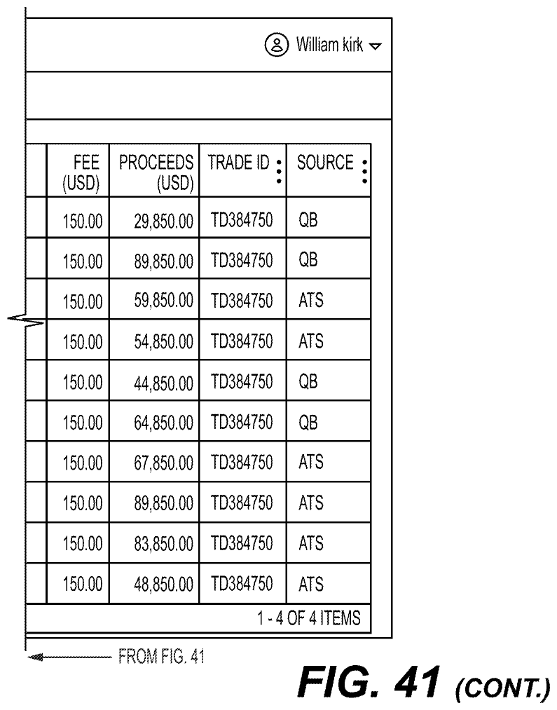

The trade blotter of the administration portal provides detailed insight into trade activity and the settlement process. An example of a trade blotter 4102 is depicted in FIG. 41. The trade blotter provides detailed insight into trade activity for the secondary market including execution details, corresponding buy/sell orders, and settlement status. The trade blotter provides the following benefits:
Option to include ROFR requirement within trade details as part of settlement process
Option for admins to bust trades as needed for invalid trading activity
Monitor payment status within the trade details page
Option to add document execution (such as a purchase agreement) as part of the post-trade settlement process, which is monitored in the trade blotter

Issuer Administration

The administration portal can be used to create issuer users within the platform and assign each user to specific companies so that they can view and manage the associated assets. Once assigned to a company, an issuer user can view and access the issuer portal where they can then see the live data on the company's assets, including offerings and securities. The assets assigned to an issuer are the ones available in the issuer platform. No other assets are available for the issuer to see or manage. Permissions can be assigned to users such view-only, admin, or site admin roles.

Data

The DAPS aggregates data across assets, asset classes and user activity to provide intelligence within the alternatives space. In doing this, the system creates:
A unique taxonomy of alternative assets and naming convention
An easy way to navigate these assets
An ability for issuers to better market to and service their investors
Creation of sentiment analysis
Creation of funds and other structures driven by underlying data from the platform

Technology and System Architecture

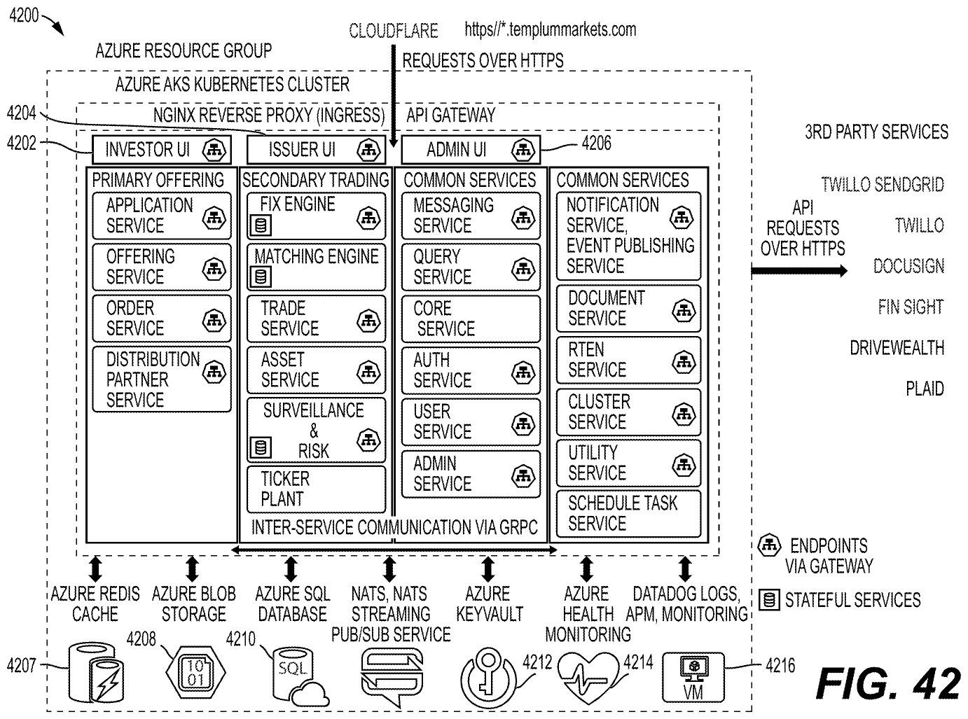

The DAPS 4200 preferably utilizes a modern and scalable architecture to support any asset class from any location as depicted in FIG. 42. The backend preferably utilizes a microservices architecture to easily allow modification and addition of new features as needed. A SaaS model supports cloud-based delivery (e.g., Azure) or on-premise deployment. Most current trading systems employ a primary server and a backup server. In contrast, the DAPS microservices architecture 4200 allows the system to be deployed or redeployed to any Azure cluster (around the globe) seamlessly, greatly minimizing downtime.

DAPS is built using modern frameworks, distributed cache and Kubernetes/Docker containers. Deployment involves the creation of a separate, private Kubernetes cluster for each client. This allows the DAPS to be scalable for marketplaces of all sizes, supporting partitions by user, security and transaction volumes.

Other third-party integrations may include customizable KYC/AML, Custodian, Banking Partner, Escrow Agent, and Transfer Agent workflows and interaction. FIX Integration for traditional capital markets is also possible.

The investor user interface 4202, issuer user interface 4204, and administrative user interface 4206 all preferably utilize REST APIs with the redistribution cache 4207, storage 4208, databases 4210, security service 4212, monitoring service 4214, and monitoring service 4216. The DAPS microservices architecture 4200 can interface with a plurality of third party services such as DocuSign (for signatures), external banking services, external payment services, etc.

Open API Infrastructure

The primary access to DAPS from third parties is through an API-driven infrastructure facilitates a completely customized marketplace and customer journey. Preferably representational state transfer (REST) and webhooks are available for third-parties to build their own user interface and/or integrate with specific third-party vendors. This architecture ensures that the system is never locked-in to any third-party vendor.

Service Add-Ons
The open architecture allows the system to seamlessly add services from third parties. These may include additional banking services, methods for managing cash or lending.

Blockchain Integration

Automation and platform security for DAPS with an optional blockchain/distributed ledger implementation is possible. Integration of a blockchain with DAPS products allows for:
Encoded compliance: Assets created for private issuance and secondary trading that are created within the blockchain protocol, and not as a database record, allows for the inclusion of investment rules, resale restrictions, and other compliance factors as part of the asset itself
Automated rules enforcement: The inclusion of transfer restrictions and compliance functionality at the protocol level automates the movement of an asset from primary to secondary markets and automatically enforces legal requirements
Transparent & secure share registry: Ownership record and transaction history maintained on the blockchain allows for a single-source of truth about a security or issuance cap table, which can integrated by any other market participant
DAPS platform is blockchain agnostic and supports multiple blockchains, distributed ledgers, and digital asset custodians

DAPS Attributes
Single (trading) system that supports a full security lifecycle-primary offering, secondary trading, corporate action, buyout/delisting
Developed specifically for alterative asset securities, but can handle offering/sale of any security, commodity, or asset, including fractionalized structures.
Third-party agnostic; ability to integrate with multiple third-parties for services such as document signature services, KYC/AML, accreditation verification, custodial services, and payment services or use of specifically developed features
Ability to support multiple trading styles, including peer-to-peer trading for primary issuance or secondary trading
Ability to manage cap table, security order, and securities transaction data natively or through integrated blockchain technology Primary Offering Attributes
Ability to choose, on a security level basis, a fixed asset price (i.e., $10/share) or offer securities through bidding process
Supports user multiple offering workflows, each configurable security level at a security level in a single environment
Ability for issuers to change configurations to make available different workflows at different times
Ability to permission users to different securities based on specific characteristics of the asset
Ability for investors to choose specific workflows at a given time based on data inputs (e.g. market information)
Combines traditional security data (i.e., price, symbol) with additional data necessary for trading alternative assets (i.e., images/other data specific to showcasing security) in a single real-time data feed

Secondary Trading Attributes
Ability to choose, on a security level basis or order basis, quotation bureau style trading (peer-to-peer), continuous order book trading, or combination in a single environment
The ability to block orders across styles of trading
The ability to suggest securities based on certain indications to match portfolio needs
Settlement workflow is configurable on a per security basis (i.e., clearing process, custodian only settlement process, or paper documents) in a single environment
Settlement workflow can be configured for issuers to approve matched trades (or not) on a per security level in a single environment
All risk and surveillance rules are run pre-order entry (vs. post trade) and configurable on a per security level
Combines traditional security data (i.e., price, symbol) with additional data necessary for trading alternative assets (i.e., images/other data specific to showcasing security) in a single real-time data feed
Ability to support real-time settlement or other settlement I.e. T1, T2

Admin Platform Attributes
Allows for simultaneous global or security level customization of risk settings, market hours, trading style, ROFR, and trade settlement workflow
Ability to add “seasoning period” that restricts moving money off platform, but not on the platform, at the deposit level or user level
Complete audit trail of user and investor activities
Ability to manually enter, or cancel trades, in marketplace; order cancellation
Ability to configure visibility of securities to users based on investor status (retail, accredited investor, qualified purchaser)
Ability to configure access to marketplace by investment objective
Data warehousing and reporting
“Super Admin” feature to customize admin rights of other users.

Technology and Architecture Abilities of DAPS
Ability to integrate with any third-party document signature platform, payment rail, KYC provider, custodian, or order management system
Cloud based fail-back architecture/disaster recovery system (vs. server-based operations)
Ability automatically scale-up or scale-down capacity in real-time based on current system demands
Ability to integrate with third party providers of additional services, to seamlessly provide banking services for users of alternatives products
Ability to aggregate and create intelligence from data on the system, including transaction and user data

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A method for conducing trades in a digital product suite (DAPS) comprising, the method comprising:
receiving, at the DAPS, an order for a security from a buyer for a trade;
matching the buyer to at least one seller offering the security for sale;
checking with an issuer of the security if trades of the security require issuer approval;
receiving, by the issued, a notification that the order has been received; and
approving or rejecting the trade by the issuer.

2. The method according to claim 1, further comprising:
automatically generating a purchase agreement for the buyer and the seller upon approval of the trade,
wherein the purchase agreement includes a first set of documents for execution by the buyer and a second set of documents for execution by the seller.

3. The method according to claim 2, further comprising:
receiving the first set of documents executed by the buyer,
wherein the first set of documents are executed using a third party electronic signature platform.

4. The method according to claim 2, further comprising:
receiving the second set of documents executed by the seller,
wherein the second set of documents are executed using the third party electronic signature platform.

5. The method according to claim 4, further comprising;
notifying the issuer that the purchase agreement has been executed; and
releasing funds from the buyer to the seller upon completion of the purchase agreement.

6. The method according to claim 5, further comprising:
automatically updating a buyer balance and a seller balance after the releasing of funds.

7. The method according to claim 1, wherein the buyer can send a counteroffer to the seller after receipt of the order.

8. The method according to claim 7, wherein the seller can reply to the counteroffer from the seller.

9. The method according to claim 1, wherein the issuer can set trading days and trading hours for the security.

10. The method according to claim 9, wherein offers are only accepted for trading days and trading hours specified by the issuer.

11. The method according to claim 1, wherein the issuer can set post-only days and post-only hours for the security.
